(19) United States
(12) Patent Application Publication
(10) Pub. No.: US 2002/0059369 A1
(43) Pub. Date: May 16, 2002

(54) Method and apparatus for creating and distributing non-sensitized information summaries to users

(76) Inventors: Christoph Kern, Santa Clara, CA (US); John Kelley, Palo Alto, CA (US); Jaideep Srivastava, Sunnyvale, CA (US); Jonathan Landers, Redwood Shores, CA (US); Dinesh K. Shanbhag, Sunnyvale, CA (US); Nishant Murarka, Redwood Shores, CA (US)

Correspondence Address: CENTRAL COAST PATENT AGENCY, PO BOX 187, AROMAS, CA, 95004, US

(21) Appl. No.: 09/826,968

(22) Filed: Apr. 4, 2001

Related U.S. Application Data
(63) Continuation-in-part of application No. 09/573,697, filed on May 19, 2000.
Application No. 09/573,697 is a continuation-in-part of application No. 09/208,740, filed on Dec. 8, 1998.

(51) Int. Cl. G06F 15/16; G06F 17/60

(52) U.S. Cl. 709/203; 709/246; 705/14

(57) ABSTRACT

A software application for creating and distributing non-sensitized summaries from sensitized data aggregated on behalf of users is provided. The software application comprises, a data processing portion of the software for de-sensitizing data and incorporating the de-sensitized data into the form of a data summary, a data caching portion of the software for storing, managing, and serving non-sensitive data summaries and a user-interface portion of the software for enabling requests for data summaries and for enabling display of the requested summaries. A user operating the interface portion of the software initiates a request to the data-caching portion of the software, the request triggering service of a completed, non-sensitive data summary or summaries created by the data processing portion of the software. In preferred embodiments, the software is implemented on cooperating nodes connected to a data-packet-network, which may be the Internet network.

### CROSS-REFERENCE TO RELATED DOCUMENTS

The present invention is a continuation-in-part (CIP) to a U.S. patent application Ser. No. 09/573,697 entitled “Method and Apparatus for Cobranding Portal Services and Normalizing Advertisements Delivered to Cobrand Subscribers”, filed on May 19, 2000, which is a CIP to a U.S. patent application Ser. No. 09/208,740 entitled “Method and Apparatus for Providing and Maintaining a User-Interactive Portal System Accessible Via Internet or Other Switched-Packet-Network”. Filed on Dec. 8, 1998, disclosures of which are incorporated herein in their entirety by reference.

### FIELD OF THE INVENTION

The present invention is in the field of Internet navigation and data gathering, and pertains more particularly to methods and apparatus for creating and distributing non-sensitized data summaries to user interfaces over a data-packet-network.

### BACKGROUND OF THE INVENTION

The information network known as the World Wide Web (WWW), which is a subset of the well-known Internet, is arguably the most complete source of publicly accessible information available. Anyone with a suitable Internet appliance such as a personal computer with a standard Internet connection may access (go on-line) and navigate to information pages (termed web pages) stored on Internet-connected servers for the purpose of garnering information and initiating transactions with hosts of such servers and pages.

Many companies offer various subscription services accessible via the Internet. For example, many people now do their banking, stock trading, shopping, and so forth from the comfort of their own homes via Internet access. Typically, a user, through subscription, has access to personalized and secure WEB pages for such functions. By typing in a user name and a password or other personal identification code, a user may obtain information, initiate transactions, buy stock, and accomplish a myriad of other tasks.

One problem that is encountered by an individual who has several or many such subscriptions to Internet-brokered services is that there are invariably many passwords and/or log-in codes to be used. Often a same password or code cannot be used for every service, as the password or code may already be taken by another user. A user may not wish to supply a code unique to the user such as perhaps a social security number because of security issues, including quality of security, that may vary from service to service. Additionally, many users at their own volition may choose different passwords for different sites so as to have increased security, which in fact also increases the number of passwords a user may have.

Another issue that can plague a user who has many passworded subscriptions is the fact that they must bookmark many WEB pages in a computer cache so that they may quickly find and access the various services. For example, in order to reserve and pay for airline travel, a user must connect to the Internet, go to his/her book-marks file and select an airline page. The user then has to enter a user name and password, and follow on-screen instructions once the page is delivered. If the user wishes to purchase tickets from the WEB site, and wishes to transfer funds from an on-line banking service, the user must also look for and select the personal bank or account page to initiate a funds transfer for the tickets. Different user names and passwords may be required to access these other pages, and things get quite complicated.

Although this preceding example is merely exemplary, it is generally known that much work related to finding WEB pages, logging in with passwords, and the like is required to successfully do business on the WEB.

A system known to the inventor and listed in the cross-reference section above provides an interactive Internet portal that enables users to store their WEB pages, user names, passwords, and a system that performs pre-defined tasks such as navigation and interaction between WEB servers based on user pre-programming (user profiles). Such a system greatly simplifies on-line or network-based business transactions.

It is known in the art that certain providers of Web services such as portal services often work with partners representing other companies offering similar services. These partnerships are termed cobrand partnerships in the art.

An example of a cobrand relationship would be that of a company A offering services through a company B to subscribers of company B, usually as if the added services were provided and maintained by company B. In a typical case of cobranding, subscribers to the cobrand partner are not aware that the added services are actually provided by a company other than the cobrand partner, or in this case, provided by company A.

An enhancement to the system described above allows for cobrand subscribers to obtain aggregated data summaries from a variety of companies through a single user interface. As described in related cases, security is of the utmost importance when handling data that may contain sensitive information. Given the sensitive and confidential nature of user information that is stored, the service requires any active network sessions to be secured by password, authentication protocols, as well as encryption protocols, for example. In a case where data is ordered on demand, that is, while a user is connected and waiting for the data results, a timeout period is imposed. If a particular session has not seen activity for a set amount of time or is idle, the system automatically times out.

A timeout routine (known in the art) typically generates an interrupt signal by a program or device that has waited a certain length of time for some input but has not received it. Many programs perform timeouts so that the program does not sit idle for an un-reasonable period waiting for user input or task completion. For example, automatic bank-teller machines perform a timeout if a password is not entered in quickly enough. This routine has proven effective in ensuring a measure of security to a user when accessing sensitive data.

In a case of ordering data summaries by virtue of interactive session over a non-secure network such as the Internet, a timeout routine causes an inconvenience to a user in that the user has to re-authenticate from the accessing device if there is a session timeout before a user is completed transacting in the session.

In the mechanics of ordering data a user generally desires only the non-sensitive portions of sensitive information such as a numerical balance associated with a particular account. This is to say that perhaps a user would like to know just the balance of their checking account at any given time but does not wish to see account numbers, pin numbers, social security numbers, and the like. Data such as this, which is deemed non-sensitive in nature, could remain on the user's screen without posing a security risk. Therefore, a session timeout would not necessarily be required to protect such non-sensitive data from long display periods or from cache entry.

What is therefore clearly needed is a method and apparatus that creates non-sensitized data summaries from a user's gross information and renders the non-sensitive portion of the requested information available to the user in a session that does not require timeout routines for security reasons. Such a method and apparatus would enhance user security by not passing the sensitive portions of user data to a user interface thereby avoiding a timeout requirement and subsequent re-authentication requirement for further transacting.

### SUMMARY OF THE INVENTION

In a preferred embodiment of the present invention, a software application for creating and distributing non-sensitized summaries from sensitized data aggregated on behalf of users is provided. The software application comprises, a data processing portion of the software for de-sensitizing data and incorporating the de-sensitized data into the form of a data summary, a data caching portion of the software for storing, managing, and serving non-sensitive data summaries and a user-interface portion of the software for enabling requests for data summaries and for enabling display of the requested summaries. A user operating the interface portion of the software initiates a request to the data-caching portion of the software, the request triggering service of a completed, non-sensitive data summary or summaries created by the data processing portion of the software.

In a preferred embodiment, the application is implemented in portions on a system of cooperating server nodes connected to a data-packet-network. In preferred aspects the network is the Internet network. In preferred application, the sensitized data is obtained from a plurality of data sources by proxy using a network navigation and data-gathering subsystem. In one aspect, the sensitive portions of data in aggregation are compared to sensitive portions of user-profile data for the purpose of identifying data for de-sensitizing. In this aspect, the sensitive portions of data in aggregation are partially de-sensitized and displayed with portions thereof intact to enable user identification of summary items contained in data summaries. In another aspect, the sensitive portions of data in aggregation are entirely eliminated and not displayed.

In a preferred aspect of the invention, the user-interface portion of the software application comprises a secondary interactive display window embedded within a primary user interface. In this aspect, the secondary interactive display window may be manipulated to spawn additional display windows. Similarly, spawned additional display windows display additional summaries.

In one embodiment, the software application further comprises a configuration tool for enabling users to configure a rule specifying a degree of non-sensitivity. This rule functions to govern how sensitive data portions are de-sensitized. In preferred applications, the non-sensitive data summaries are rooted in the class of HTML derived languages. In one aspect, the non-sensitive data summaries are HTML-based information pages. In another aspect, the non-sensitive data summaries are XML-based information pages.

In still another aspect of the present invention, a server-driven system for creating and distributing non-sensitive data summaries from sensitized data aggregated on behalf of users is provided. The system comprises, a data-packet-network for facilitating communication to, from, and within the system, a processing server connected to the data-packet-network for de-sensitizing data from aggregation and for creating data summaries using the de-sensitized data, a cache server connected to the data-packet-network for accessing, obtaining, and serving non-sensitive data summaries to requesting users and a user-interface server connected to the data-packet-network for facilitating requests from users for summaries and for enabling service and display of the requested summaries.

In all aspects, the communication between components of the system and communication between practitioners of the system and components of the system occurs on a data-packet-network, which in preferred application is the Internet network. In one aspect, the sensitized data is obtained from a plurality of data sources by proxy using a network navigation and data-gathering subsystem. In this aspect, the sensitive portions of data in aggregation are compared to sensitive portions of user-profile data for the purpose of identifying data for de-sensitizing. In the same aspect, the sensitive portions of data in aggregation are partially de-sensitized and displayed with portions thereof intact to enable user identification of summary items contained in data summaries. In another aspect, the sensitive portions of data in aggregation are entirely eliminated and not displayed.

In preferred applications, the non-sensitive data summaries are created using a markup language rooted in the class of HTML derived languages. In one aspect, the non-sensitive data summaries are HTML-based information pages. In another aspect, the non-sensitive data summaries are XML-based information pages.

In yet another aspect of the present invention, a method for creating and distributing non-sensitive data summaries from data aggregated on behalf of users is provided. The method comprises the steps of, (a) receiving and aggregating data on behalf of requesting users, (b) de-sensitizing the aggregated data, (c) incorporating the de-sensitized data into the form of one or more non-sensitive data summaries, (d) requesting the non-sensitive data summaries or summary to be delivered to an interface during a data session, and (e) displaying the non-sensitive summary or summaries for user review.

In a preferred embodiment steps (a)-(e) are practiced in conjunction with a data-packet-network, which is the Internet network in preferred applications. In another embodiment, a step is added between (a) and (b) for identifying sensitive data portions through database comparison. In this aspect, the database used in the comparison is a user-profile database.

Now, for the first time a method and apparatus that creates non-sensitized data summaries from a user's sensitive information and renders the non-sensitive portion of the requested information available to the user in a session that does not require timeout routines for security reasons is provided. Such a method and apparatus enhances user security by not passing the sensitive portions of user data to a user interface thereby avoiding a timeout requirement and subsequent re-authentication requirements for further transacting.

### BRIEF DESCRIPTION OF THE DRAWING FIGURES

FIG. 1 is an overview of an Internet portal-system and network according to an embodiment of the present invention.

FIG. 2 is an exemplary plan view of a personalized Portal home page application as it may be seen on a display monitor according to an embodiment of the present invention.

FIG. 3 is a flow diagram illustrating user interaction with the Internet portal of FIG. 1.

FIG. 4 is an overview of cobrand architecture according to an embodiment of the present invention.

FIG. 5 is a plan view of a cobrand control panel according to an embodiment of the present invention.

FIG. 6 is a plan view of a cobrand user interface according to an embodiment of the present invention.

FIG. 7 is an overview of a communication network wherein banner advertising is practiced according to prior art.

FIG. 8 is an overview of a communications network wherein banner advertising is practiced according to the present invention.

FIG. 9 is an architectural overview of a communication network wherein non-sensitized data summaries are created and distributed according to an embodiment of the present invention.

FIG. 10 is a block diagram illustrating software and data flow within the network of FIG. 9 according to an embodiment of the present invention.

FIG. 11 is a plan view of a cobrand interface illustrating non-sensitized data results according to an embodiment of the present invention.

FIG. 12 is a flow diagram illustrating system and user steps involved in ordering and receiving non-sensitized data summaries according to an embodiment of the present invention.

### DESCRIPTION OF THE PREFERRED EMBODIMENTS

According to a preferred embodiment of the present invention, a unique Internet portal is provided and adapted to provide unique services to users who have obtained access via an Internet or other network connection from an Internet-capable appliance. Such an interface provides users with a method for storing many personal WEB pages and further provides search function and certain task-performing functions. The methods and apparatus of the present invention are taught in enabling detail below.

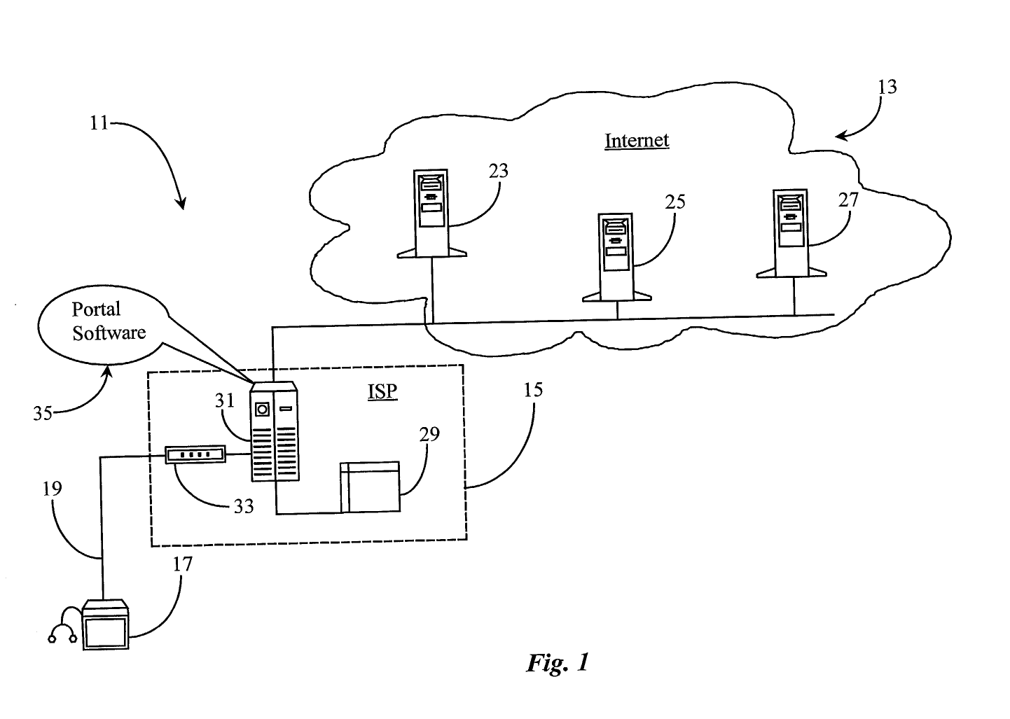

FIG. 1 is an overview of an Internet portal system 11 and Internet network 13 according to an embodiment of the present invention. Portal system 11, in this embodiment, operates as an ISP in addition to a unique network portal, but may, in other embodiments be implemented as a stand-alone Internet server. In yet other embodiments the service and apparatus described herein may also be provided by such as a search and listing service (AltaVista™, Yahoo™) or by any other enterprise hosting a WEB-connected server.

Internet 13 is representative of a preferred use of the present invention, but should not be considered limiting, as the invention could apply in other networks and combinations of networks.

ISP 15 in this embodiment comprises a server 31, a modem bank 33, represented here by a single modem, and a mass storage repository 29 for storing digital data. The modem bank is a convenience, as connection to the server could be by another type of network link. ISP 15, as is typical in the art, provides Internet access services for individual subscribers. In addition to well-known Internet access services, ISP 15 also provides a unique subscription service as an Internet portal for the purpose of storing many WEB pages or destinations along with any passwords and or personal codes associated with those pages, in a manner described in more detail below. This unique portal service is provided by execution of Portal Software 35, which is termed by the inventors the Password-All suite. The software of the invention is referred to herein both as the Portal Software, and as the Password-all software suite. Also, in much of the description below, the apparatus of the invention is referred to by the Password-All terminology, such as the Password-All Server or Password-All Portal.

ISP 15 is connected to Internet 13 as shown. Other equipment known in the art to be present and connected to a network such as Internet 13, for example, IP data routers, data switches, gateway routers, and the like, are not illustrated here but may be assumed to be present. Access to ISP 15 is through a connection-oriented telephone system as is known in the art, or through any other Internet/WEB access connection, such as through a cable modem, special network connection (e.g. T1), ISDN, and so forth. Such connection is illustrated via access line 19 from Internet appliance 17 through modem bank 33.

In a preferred embodiment a user has access to Internet Password-All Portal services by a user name and password as is well-known in the art, which provides an individualized WEB page to the subscriber. In another embodiment wherein a user has other individuals that use his or her Internet account, then an additional password or code unique to the user may be required before access to portal 31 is granted. Such personalized Portal WEB pages may be stored in repository 29, which may be any convenient form of mass storage.

Three Internet servers 23, 25, and 27, are shown in Internet 13, and represent Internet servers hosted by various enterprises and subscribed to by a user operating appliance 17. For example, server 23 may be a bank server wherein interactive on-line banking and account managing may be performed. Server 25 may be an investment server wherein investment accounts may be created and managed. Server 27 may be an airline or travel server wherein flights may be booked, tickets may be purchased, and so on. In this example, all three servers are secure servers requiring user ID and password for access, but the invention is not necessarily limited to just secure services.

In a preferred embodiment of the present invention, a subscribing user operating an Internet-capable appliance, such as appliance 17, connects to Password-All Portal system 11 hosted by ISP 15, and thereby gains access to a personalized, interactive WEB page, which in turn provides access to any one of a number of servers on Internet 13 such as servers 23, 25, and 27, without being required to enter additional passwords or codes. In a preferred embodiment the software that enables this service is termed Password-All by the inventors. Password-All may be considered to be a software suite executing on the unique server, and in some instances also on the user's station (client). Additional interactivity provided by portal software 35 allows a connected user to search his listed pages for information associated with keywords, text strings, or the like, and allows a user to program user-defined tasks involving access and interaction with one or more Internet-connected servers such as servers 23, 25, and 27 according to a pre-defined time schedule. These functions are taught in enabling detail below.

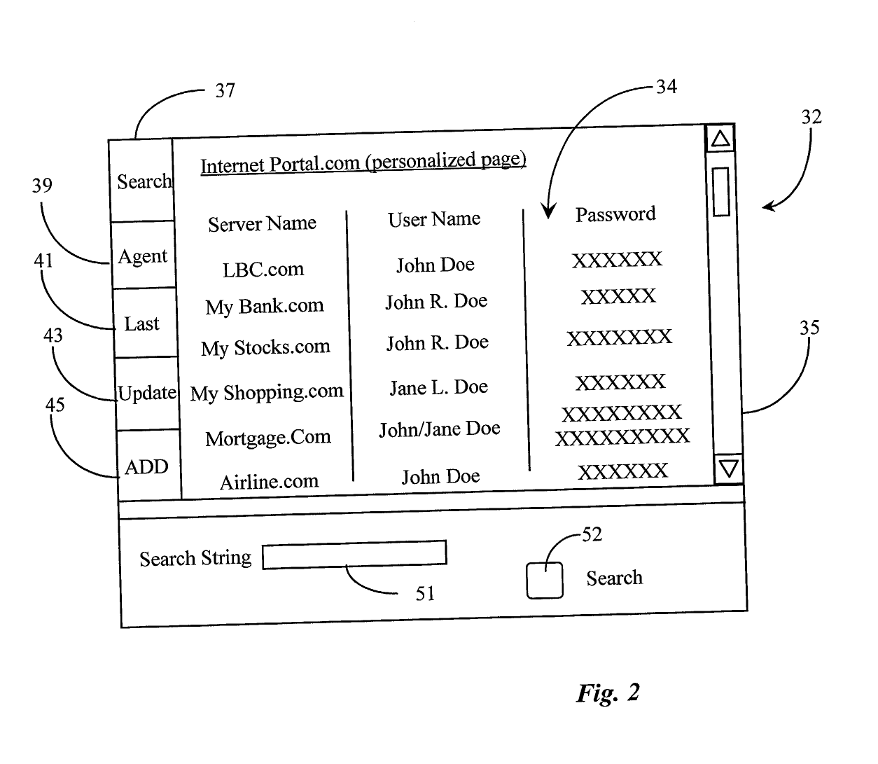

FIG. 2 is an illustration of a personalized portal page as may be seen on a display monitor according to an embodiment of the present invention, provided by Password-All Portal software 35 executing on server 31, in response to secure access by a subscriber. Page 32 presents an interactive listing 34 of user-subscribed or member WEB pages, identified in this example by URL, but which may also be identified by any convenient pseudonym, preferably descriptive, along with user name and typically encrypted password information for each page. Listed in a first column under destination, are exemplary destinations LBC.com, My Bank.com, My Stocks.com, My shopping.com, Mortgage.com, and Airline.com. These are but a few of many exemplary destinations that may be present and listed as such on page 33. In order to view additional listings listed but not immediately viewable from within application 33, a scroll bar 35 is provided and adapted to allow a user to scroll up or down the list to enable viewing as is known in the art.

Items listed in list 34 in this example may be considered destinations on such as servers 23, 25, and 27 of FIG. 1. Typically the URL associated with an item on this list will not take a user to a server, per se, but to a page stored on a server. User names and password data associated with each item in list 34 are illustrated in respective columns labeled user name, and password, to the right of the column labeled destination. Each listing, or at least a portion of each listing, is a hyperlink invoking, when selected, the URL to that destination. In some instances a particular service may have more than one associated URL. For example, My Bank.com may have more than one URL associated for such as different accounts or businesses associated also with a single subscriber. In this case there may be a sub-listing for different destinations associated with a single higher-level listing. This expedient is not shown, but, given this teaching the mechanism will be apparent to those with skill in the art.

In some embodiments one page 33 may be shared by more than one user, such as a husband and wife sharing a common account and subscription. An instance of this is illustrated herein with respect to the server labeled Mortgage.com wherein both a John and a Jane Doe are listed together under the column labeled user name. In another embodiment, a network of individuals, perhaps business owners, authorized co-workers, investment parties, or the like may share one application. In this way, system 11 may be adapted for private individuals as well as business uses.

After gaining access to application 33 which is served via Internet portal server 31 of FIG. 1, a user may scroll, highlight, and select any URL in his or her list 34 for the purpose of navigation to that particular destination for further interaction. Application 33 already has each password and user name listed for each URL. It is not necessary, however, that the password and user name be displayed for a user or users. These may well be stored transparently in a user's profile, and invoked as needed as a user makes selections. Therefore, a user is spared the need of entering passwords and user names for any destinations enabled by list 34. Of course, each list 34 is built, configured and maintained by a subscribing user or users, and an editing facility is also provided wherein a user may edit and update listings, including changing URL's adding and deleting listings, and the like.

In another aspect of the invention new listings for a user's profile, such as a new passthrough to a bank or other enterprise page, may be added semi-automatically as follows: Typically, when a user opens a new account with an enterprise through interaction with a WEB page hosted by the enterprise, the user is required to provide certain information, which will typically include such as the user's ID, address, e-mail account, and so forth, and typically a new user name and password to access the account. In this process the user will be interacting with the enterprise's page from his/her browser. A Password-All plug-in is provided wherein, after entering the required information for the new enterprise, the user may activate a pre-determined signal (right click, key stroke, etc.), and the Password-All suite will then enter a new passthrough in the user's Password. All profile at the Password-All Portal server.

In a related method for new entries, the enterprise hosting the Password-All Portal may, by agreement with other enterprises, provide log-in and sign-up services at the Password-All Portal, with most action transparent to the user. For example, there may be, at the Password-All Portal, a selectable browser list of cooperating enterprises, such as banks, security services, and the like, and a user having a Password-All Portal subscription and profile may select among such cooperating enterprises and open new accounts, which will simultaneously and automatically be added to the Password-All Portal page for the user and to the server hosted by the cooperating enterprise. There may be some interactivity required for different accounts, but in the main, much information from the user's profile may be used directly without being re-entered.

The inventors have anticipated that many potential users may well be suspicious of providing passwords and user names to an enterprise hosting a Password-All Portal Server executing a service like Password-All according to embodiments of the present invention. To accommodate this problem, in preferred embodiments, it is not necessary that the user provide the cleartext password to Password-All. Instead, an encrypted version of each password is provided. When a user links to his passthrough page in Password-All at the Password-All Portal server, when he/she invokes a hyperlink, the encrypted password is returned to the user's system, which then, by virtue of the kept encryption key or master password, invokes the true and necessary password for connection to the selected destination. It is thus not necessary that cleartext passwords be stored at the Password-All Portal server, where they may be vulnerable to attack from outside sources, or to perceived misuse in other ways as well.

In a related safety measure, in a preferred embodiment of the invention, a user's complete profile is never stored on a single server, but is distributed over two or more, preferably more, servers, so any problem with any one server will minimize the overall effect for any particular user.

Password-All, as described above, allows a user to access a complete list of the user's usual cyberspace destinations, complete with necessary log-on data, stored in an encrypted fashion, so a user may simply select a destination (a hyperlink) in the Password-All list, and the user's browser then invokes the URL for the selected destination. In an added feature, Password-All may display banner ads and other types of advertisement during the navigation time between a hyperlink being invoked and the time the destination WEB page is displayed.

In yet another embodiment of the invention, a user/subscriber need not access the Password-All page to enjoy the advantages of the unique features provided. In this variation, a Plug-In is provided for the subscriber's WEB browser. If the subscriber navigates by use of the local browser to a WEB page requiring a secure log-in, such as his/her on-line banking destination, when the subscriber is presented with an input window for ID and Password, the plug in may be activated by a predetermined user input, such as a hot key or right click of the mouse device. The plug-in then accesses, transparently, the Password-All page (which may be cached at the client), and automatically accesses and provides the needed data for log-on.

In yet another aspect of the invention a search option 37 allows a user to search list 34 for specific URL's based on typed input such as keywords or the like. In some cases, the number of URL's stored in list 34 can be extensive making a search function such as function 37 an attractive option. A criteria dialog box 51 illustrated as logically separated from and below list 34 is provided and adapted to accept input for search option 37 as is known in the art. In one embodiment, search option 37 may bring up a second window wherein a dialog box such as box 51 could be located.

In another aspect of the invention the search function may also be configured in a window invoked from window 33, and caused to search all or selected ones of listed destinations, and to return results in a manner that may be, at least to some extent, configured by a user. For example, a dialog box may be presented wherein a user may enter a search criteria, and select among all of the listed destinations. The search will then be access each of the selected destinations in turn, and the result may be presented to the user as each instance of the criteria is found, or results may be listed in a manner to be accessed after the search.

Preferably the search function is a part of the Password-All Portal software, available for all users, and may be accessed by hyperlinks in user's personal pages. In some embodiments users may create highly individualized search functions that may be stored in a manner to be usable only by the user who creates such a function.

In many aspects of the present invention a knowledge of specific WEB pages, and certain types of WEB pages, is highly desirable. In many embodiments characteristics of destination WEB pages are researched by persons (facilitators) maintaining and enhancing Password-All Portal software 35, and many characteristics may be provided in configuration modules for users to accomplish specific tasks. In most cases these characteristics are invoked and incorporated transparent to the user.

In yet another aspect of the present invention, the Password-All suite is structured to provide periodic reports to a user, in a manner to be structured and timed by the user, through the user's profile. For example, reports of changes in account balances in bank accounts, stock purchases, stock values, total airline travel purchases, frequent-flier miles, and the like may be summarized and provided to the users in many different ways. Because the Password-All Portal server with the Password-All software site handles a broad variety of transactional traffic for a user, there is an opportunity to summarize and collect and process statistics in many useful ways. In preferred embodiments of the invention such reports may be furnished and implemented in a number of different ways, including being displayed on the user's secure personal WEB page on the Password-All Portal.

In addition to the ability of performing tasks as described above, task results including reports, and hard documents such as airline tickets may be sent over the Internet or other data packet-networks to user-defined destinations such as fax machines, connected computer nodes, e-mail servers, and other Internet-connected appliances. All tasks may be set-up and caused to run according to user-defined schedules while the user is doing something else or is otherwise not engaged with the scheduled task.

In another embodiment of the present invention, recognizing the increasing use of the Internet for fiscal transactions, such as purchasing goods and services, a facility is provided in a user's profile to automatically track transactions made at various destinations, and to authorize payment either on a transaction-by-transaction basis, or after a session, using access to the user's bank accounts, all of which may be pre-programmed and authorized by the user.

Other functions or options illustrated as part of application 35 include a last URL option 41, an update function 43, and an add function 45. Function 41 allows a user to immediately navigate to a last visited URL. Update function 43 provides a means of updating URL's for content and new address. An add function enables a user to add additional URL's to list 34. Similarly, function 45 may also provide a means to delete entries. Other ways to add accounts are described above. It should be noted that the services provided by the unique Password-All Portal in embodiments of the present invention, and by the Password-All software suite are not limited to destinations requiring passwords and user names. The Password-All Portal and software in many embodiments may also be used to manage all of a user's bookmarks, including editing of bookmarks and the like. In this aspect, bookmarks will typically be presented in indexed, grouped, and hierarchical ways.

There are editing features provided with Password-All for adding, acquiring, deleting, and otherwise managing bookmarks. As a convenience, in many embodiments of the invention, bookmarks may be downloaded from a user's Password-All site, and loaded onto the same user's local browser. In this manner, additions and improvements in the bookmark set for a user may be used without the necessity of going to Password-All. Further, bookmarks may be uploaded from a user's local PC to his/her home page on the Password-All site by use of one or more Password-All plug-ins.

It will be apparent to the skilled artisan, given the teaching herein, that the functionality provided in various embodiments of the invention is especially applicable to Internet-capable appliances that may be limited in input capability. For example, a set-top box in a WEB TV application may well be without a keyboard for entering IDs and Passwords and the like. In practice of the present invention keyboard entry is minimized or eliminated. The same comments apply to many other sorts of Internet appliances.

In preferred embodiments of the invention, once a subscriber-user is in Password-All, only an ability to point-and-click is needed for all navigation. To get into the Password-All site, using a limited apparatus, such as an appliance without a keyboard or keypad, a Smartcard or embedded password may be used, or some other type of authentication.

It will be apparent to one with skill in the art that an interactive application such as application 33 may be provided in a form other than a WEB page without departing from the spirit and scope of the present invention. For example, an application such as application 33 may be provided as a downloadable module or program that may be set-up and configured off-line and made operational when on-line.

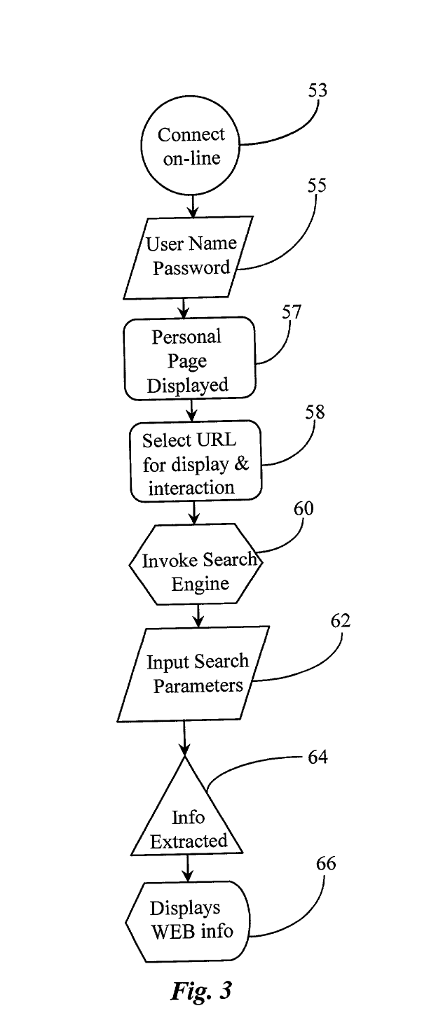

FIG. 3 is a flow diagram illustrating user interaction with the Internet Password-All Portal of FIG. 1. The following process steps illustrated, according to an embodiment of the present invention, are intended to illustrate exemplary user-steps and automated software processes that may be initiated and invoked during interaction with an Internet portal of the present invention such as portal 31 of FIG. 1. In step 53 a user connects to the Internet or another previously described switched-packet network via a compatible appliance such as Internet appliance 17 of FIG. 1.

At step 55, a user enters a user-name and password which, in one embodiment, may simply be his ISP user name and password. In another embodiment, a second password or code would be required to access an Internet portal such as portal server 31 of FIG. 1 after logging onto the Internet through the ISP. In some cases, having a special arrangement with the ISP, there may be one password for both Internet access through the ISP and for Password-All. At step 57 a personal WEB page such as page 32 of FIG. 2 is displayed via Internet portal server 31. At minimum, the personalized WEB page will contain all user configured URL's, and may also be enhanced by a search function, among other possibilities.

In step 58 a user will, minimally, select a URL from his or her bookmarked destinations, and as is known by hyperlink technology, the transparent URL will be invoked, and the user will navigate to that destination for the purpose of normal user interaction. In this action, the Password-All Portal software transparently logs the user on to the destination page, if such log-on is needed.

At step 60 the user invokes a search engine by clicking on an option such as described option 37 of FIG. 2. At step 62, the user inputs search parameters into a provided text field such as text field 51 of FIG. 2. After inputting such parameters, the user starts the search by a button such as button 52. The search engine extracts information in step 64. Such information may be, in one option, of the form of URL's fitting the description provided by search parameters. A searched list of URL's may be presented in a separate generated page in step 66 after which a user may select which URL to navigate to. In an optional search function, the user may provide search criteria, and search any or all of the possible destinations for the criteria.

In another embodiment wherein WEB pages are cached in their presentable form, information extracted in step 64 may include any information contained in any of the stored pages such as text, pictures, interactive content, or the like. In this case, one displayed result page may provide generated links to search results that include the URL associated with the results. Perhaps by clicking on a text or graphic result, the associated WWB page will be displayed for the user with the result highlighted and in view with regards to the display window.

Distributed Co-Brand Application

According to an embodiment of the present invention, a cobrand architecture 67 is provided and adapted to enable efficient cobranding between a service provider and multiple cobrand partners. Architecture 67 comprises a mix of elements, which are known in the art, and those which are provided to enable practice of the present invention. Elements, which are known and existing in the art will be described as such while elements new to the art will be described within the scope of the present invention.

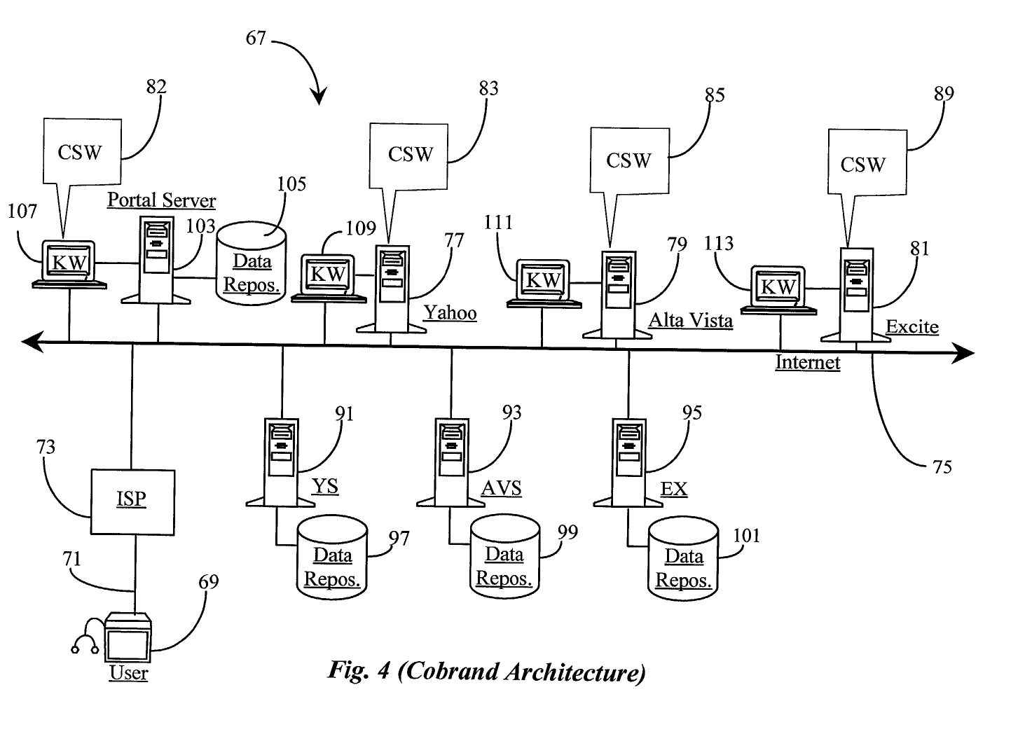

FIG. 4 is an overview of cobrand architecture 67 according to an embodiment of the present invention. An Internet backbone of 75 is illustrated herein and represents all of the known lines, connection points, and equipment that make up the Internet network as a whole. Therefore, there is no geographic limit to the practice of the present invention. Connected to Internet backbone 75, are 4 exemplary servers. These are, a portal server 103, a portal server 77, a portal server 79, and a portal server 81. In this example, each portal server 103 through 81 is connected to backbone 75 by virtue of network connections as is known in the art.

Portal server 103 represents a server hosted by a main service provider seeking to cobrand services to business partners termed cobrand partners by the inventor. Server 77 represents a portal server hosted, in this example, by a company known as Yahoo™, which provides search and portal services to users. Server 79 and server 81 are hosted, in this example, by the well-known companies AltaVista™ and Excite™ respectively. Each of the three aforementioned companies specialize in providing search capabilities and limited portal services to registered users and/or subscribers. The companies hosting servers 77, 79, and 81 may be termed cobrand partners of a service-providing company hosting server 103.

Servers 77-81 may be adapted for other services and may be hosted by other companies than the services and companies mentioned in this example without departing from the spirit and scope of the present invention. The inventor chooses to illustrate server 77-81 as being hosted by the aforementioned companies simply because they are well-known and enjoy a large customer base. It may be assumed in this example, that each company hosting a portal server has at least one knowledge worker under employ as illustrated in this example by a knowledge worker 107 associated with portal server 103, a knowledge worker 109 associated with portal server 77, a knowledge worker 111 associated with portal server 79, and a knowledge worker 113 associated with portal server 81.

Knowledge workers 107-113 are endowed with various computer programming and engineering skills that are required for successful function of each hosting company. In actual practice, there would likely be many more knowledge workers under the employ of each company than are illustrated in this example. The inventor deems that the illustration of 4 such knowledge workers is adequate for the purpose of explanation of the present invention. In this example, knowledge workers 107-113 have connections to Internet backbone 75 and separate data connections to associated servers 103-81. It may be assumed that knowledge workers 107-113 are operating powerful personal computers as illustrated herein by computer icons.

Also illustrated as connected to Internet backbone 75, are servers 91, 93, and 95. Servers 91-95 represent Internet servers hosted by a company (service-providing company) also hosting server 103. Server 91, also labeled YS (Yahoo Server) is provided for cobrand subscribers visiting server 77. Similarly, server 93, also labeled AVS (Altavista server) is provided for a cobrand subscribers visiting server 79. The same is true for server 95, also labeled EX (Excite). Servers 103, 91, 93, and 95 have data repositories connected thereto and adapted for storing information about subscribers such as account information, profile information, user name and password information, and any other data about subscribers that may be deemed applicable for storage. For example, a data repository 105 is connected to portal server 103. Similarly, data repositories 97, 99, and 101 are connected to servers 91, 93, and 95 respectively. Data repositories 105-101 may, in one embodiment, be internal repositories instead of external repositories. Furthermore, servers 77, 79, and 81 may also be assumed to have data repositories connected thereto although none are shown.

A user 69, illustrated herein by an Internet appliance icon, connects to an Internet service provider (ISP) 73 by virtue of a telephone line 71. ISP 73 is adapted to provide standard dial-up Internet connections as is known in the art. ISP 73 is connected to Internet backbone 75 by virtue of an Internet-access line of 74. Telephone line 71 may be a normal connection-oriented-switched-telephony (COST) telephone line, or it may be a digital service line adapted for fast Internet connection such as a digital subscriber line (DSL), an integrated-services-digital-network (ISDN) line, or any other type of telephone line. User 69 may also access Internet 75 via a wireless connection without departing from the spirit and scope of the present invention. All that is required for user 69 to access Internet 75, is an Internet appliance capable, by virtue of software, for accessing the Internet and an appropriate connection means such as to ISP 73. It will be apparent to one with skill in the art that there are many alternative methods for connecting to an Internet network.

In this example, user 69 represents any number of users accessing the Internet for the purpose of interacting with Web services provided by the companies hosting servers 77, 79, 81, and in some embodiments, server 103. For purpose of discussion, it is assumed herein the user 69 is a regular patron of at least Yahoo™, Alatavista™, and Excite™. Furthermore, the skilled artisan will appreciate that there they may be many more services hosted by still more companies that are accessible to users through Internet 75 that are not represented in this example. It is restated herein, that the company hosting portal server 103 also maintains and hosts servers 91, 93, and 95, on behalf of companies hosting servers 77, 79, and 81, in the spirit of a unique cobrand relationship between the companies. It is to this aspect that the method and apparatus of the present invention relates.

A novel cobrand software application (CSW) 82 is illustrated herein as accessible to KW 107. CSW 82 is provided and adapted as a self-contained configuration application which enables a cobrand service to be created and implemented without requiring extensive software engineering, software installation, hardware reconfiguration, or other extensive effort normally required of a service-providing company engaged in implementing cobrand services through Web interfaces maintained by cobrand partners, represented in this example, by Yahoo™, Altavista™, and excite™. CSW 82 is termed a cobrand control panel by the inventor, and may be referred to, hereinafter in this specification, as a cobrand control panel or simply control panel. It is noted herein, that instances of cobrand control panel (CSW) are illustrated as resident in servers 77, 79, and 81, and accessible to KWs 109, 111, and 113 respectively. These instances of control panel are labeled with element numbers 83, 85, and 89. Control panel instances 83-89, running on servers 77-81 respectively, represent a received versions of cobrand control panel 82 distributed over Internet backbone 75 by a company hosting portal server 103 and providing cobrand services.

In practice of the present invention, the existence of cobrand control panel 82 in combination with cobrand architecture 67 provides a streamlined and efficient method for creating and implementing cobrand services on behalf of cobrand partners hosting servers 77-81.

Instead of attempting to install cobrand functionality to servers 77-81, the company providing cobrand services, which in this example, is a company hosting portal server 103 provides and maintains Web servers 91-95 has dedicated cobrand Web sites for the companies hosting servers 77-81. Distributed instances of control panel 82 (83-89) are self-contained toolkits which may be manipulated by KWs 109-113 respectively for the purpose of selecting offered services and authoring HTML Web pages that will be installed in servers 91-95 respectively. Each cobrand partner controls the look and feel of authored cobrand Web pages such that individual users, represented herein by user 69, are unaware that the added functionality made available by the providing company is not generic to a cobrand partner's normal service.

A general process for implementing successful cobrand services on behalf of a cobrand partner maybe understood through discussion of the following example. KW 107 distributes generic control panel 82 over Internet backbone 75 to server 77 (Yahoo™) where it appears as distributed control panel 83. Control panel 83 contains complete description of all offered services and the appropriate Web-building tools for creating Web interfaces. An example of such a tool would be an HTML editor. KW 109 accesses control panel 83, selects services, and builds WEB pages giving access to the selected services. Control panel 83 allows KW 109 to import features generic to existing Yahoo™ interfaces for creating cobrand Web pages that mirror Yahoo's look and feel.

When KW 109 has completely configured control panel 83, it is submitted back to its source (portal server 103) and is again accessible to KW 107. KW 107 reviews and approves the completed control panel and installs the complete package into reserved server 91 and data repository 97. A hyperlink to server 91 is provided and embedded on such as a main page within server 77 along with an interactive registration form if applicable. In one embodiment, only a hyperlink is provided and server 77 and user registration takes place and server 91. A hyperlink provided within a portal page hosted on server 77 linking to a page hosted in server 91 may be a simple icon labeled my accounts, or some other applicable name.

After cobrand services are installed and active within server 91, user 69 may access server 77 during the course of normal Internet navigation and interaction. Upon noticing and invoking the provided linked to server 91, user 69 may be prompted to register for receiving added functionality, after which, he or she may ad Web accounts for servicing. In this example, the company hosting portal server 103 specializes and data gathering and aggregation through a single interface. However, this should not be construed as a limitation to practice of the present invention. A service providing company may offer a wide variety of disparate Internet services, and may cobrand such services using the method and architecture of the present invention.

Once user 69 is registered and authorized two use cobrand services setup and running in server 91, he or she may also register for and setup accounts for cobrand services offered through server 79 and 81. In this way, data gathering an aggregation services may be obtained for all of a user's Web accounts and/or services with through Web interfaces frequently visited by and known to user 69. In one embodiment, the service-providing company handles all registration requirements for new users. That is to say that once user 69 clicks on an appropriate hyperlink embedded in a main page posted in one of server 77-81, he or she will be immediately directed to the appropriate cobrand server 91-95 to begin registration. In this embodiment, every aspect of servicing users is performed by the service-providing company. The only requirement of a cobrand partner in this case is to maintain a link to an appropriate cobrand server. The exact implementation of individual responsibility with respect to registration and billing will depend on the nature of agreement between the participating companies. There are many possibilities. More detail about a cobrand control panel will be provided below.

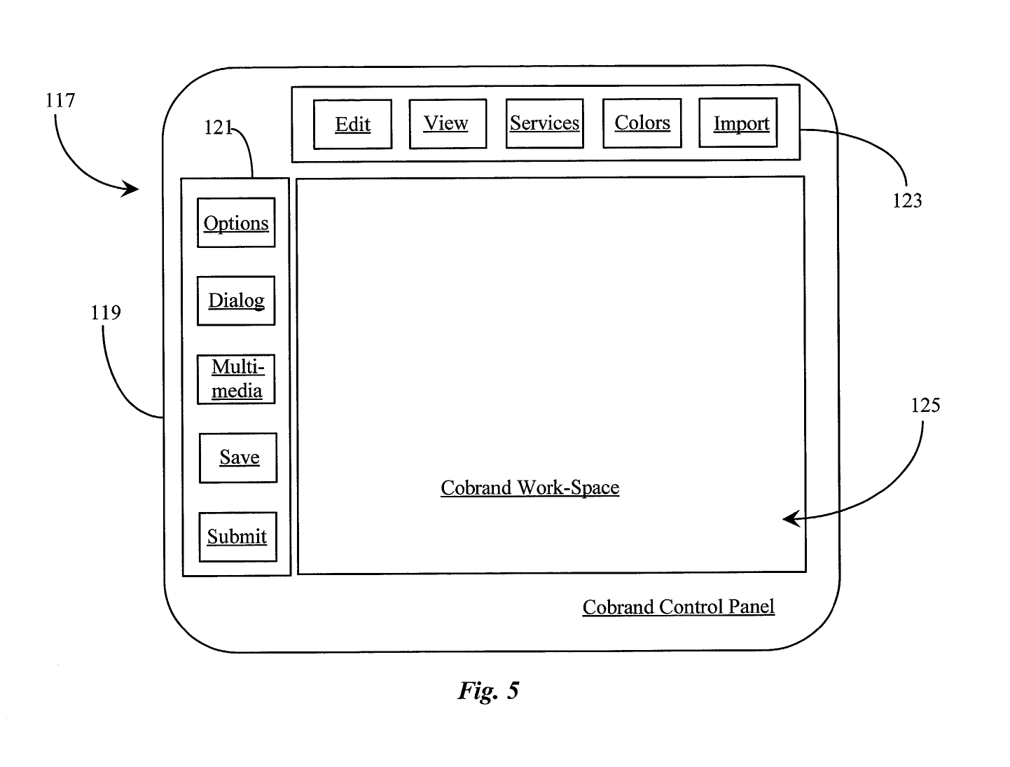

FIG. 5 is a plan view of a cobrand control panel 117 according to an embodiment of the present invention. Cobrand control panel 117, in this example, is analogous to control panel 82 illustrated in FIG. 4 above. Control panel 117 is a self-contained toolkit as previously described with reference to control panel 82 of FIG. 4. In this example, a control-panel window is displayed on an appropriate PC monitor upon invocation of software 117, which may first appear as a control panel .exe icon. In this embodiment, control panel 117 represents an installable application, which would be installed as a permanent program on an appropriate computer connected to a receiving server, or on the receiving server accessible by a connected computer. In another embodiment, control panel 117 maybe provided installed in a separate server, which is accessed over the Internet by knowledge workers of cobrand prospects. There are many possibilities.

Control-panel window 119 comprises, in this example, a tool bar 121, a tool bar 123, and a cobrand workspace 125. Tool bar bars 121 and 123 are provided and adapted with controls, which may be invoked by a knowledge worker configuring a cobrand service-package. In place of active tool bars, a drop-down menu or menus may be provided without departing from the spirit and scope of the present invention. There are many possible implementations. For example, tool bar 123 contains an edit, function labeled as such, that is provided for enabling editing of completed portions of control panel 117. A view function, labeled as such, is provided within tool bar 123 and adapted for enabling viewing of various portions or steps of cobrand configuration process. A services function, labeled as such, enables a knowledge worker to browse and select offered services for implementation. A colors function, labeled as such, is provided within tool bar 123, and enables a knowledge worker to implement color schemes and so on to works in progress. In import function, labeled as such, is provided within tool bar 123, and is adapted to enable a knowledge worker to import features and functionality generic to the particular cobrand partner. Proprietary logos, copyrighted material, images, proprietary search interfaces, and so on are examples of imported features.

Tool bar 121 contains additional exemplary functions, which will be described individually as follows. An options function is provided within tool bar 121 and adapted to enable a knowledge worker to browse various options available in configuring cobrand package. In a dialog function, labeled as such, is provided within tool bar 121 and adapted to enable a knowledge worker to create interactive dialog functions and embed them into cobrand Web pages. A multimedia function, labeled as such, in spite of within tool bar 121 and adapted to enable a knowledge worker to create and embed multimedia functionality into cobrand Web pages. A save function, labeled as such, is provided within tool bar 121 and adapted to enable a knowledge worker to save completed works. A submitted function, labeled as such, is provided within two or 121 and adapted to enable a knowledge worker to submit a completed cobrand package to a service-providing company. A cobrand workspace 125 is provided within cobrand window 119 and adapted as a workspace for generating HTML pages, testing various functions, and so on.

The inventor intends that control panel 117, as described in this example, represent just one possibility among many alternative possibilities for implementing an interactive and self-contained control panel for configuring cobrand services. Furthermore, the functions represented within tool bars 121 and 123 are intended to be exemplary only of types of functions that may be provided within control panel 117. One with skill in the art will appreciate that there may be many alternative presentations. Control panel 117 contains all of the functions required in order to successfully create, configure, and implement a cobrand-service.

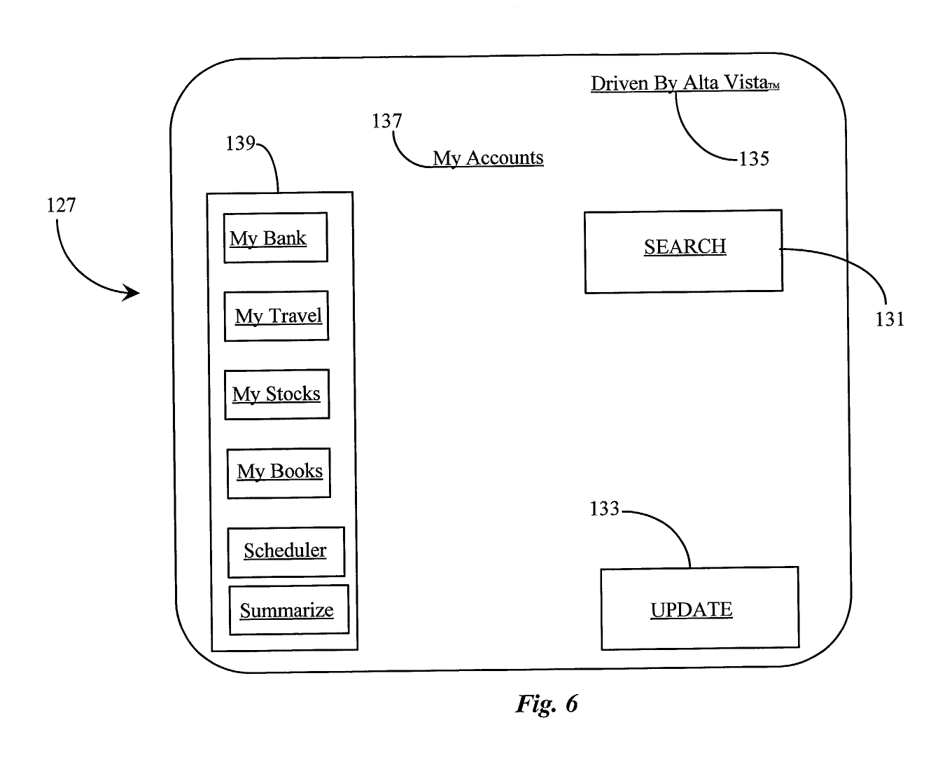

FIG. 6 is a plan view of a cobrand user interface 127 according to an embodiment of the present invention. Cobrand-user interface 127 is, in preferred embodiments, an interactive web page created from within control panel 117 of FIG. 5, and hosted on one of cobrand servers 91-95 of FIG. 4. Interface 127 may be assumed to be a main cobrand web page as seen by a user interacting with cobranded services. In a case wherein a service-providing company is a data aggregation service, then interface 127 may represent a starting page or a portal page from whence numerous accounts may be aggregated and summarized for data. A title for interface 127 may be as simple as a title illustrated herein as My Accounts and labeled with element number 137. In the particular example, a text notation labeled Driven by AltaVista™ and represented by element number 135, identifies the particular cobrand partner. As previously described, interface 127 may have although look and feel of a main public interface hosted by AltaVista™ such that a user is not aware of the involvement of a service-providing company and providing value-added services.

A search interface 131 is provided an embedded within interface 127 and is adapted to enable a user to perform a keyword search. Interface 131, may be a version of the interface that is available on a cobrand partner's main web page. Preferably, the look and function of interface 131 is identical to a standard search function provided by a cobrand partner made available to it's standard user fair. A tool bar 139 is provided an embedded within interface 127. Tool bar 139 contains interactive selections of the user accounts added to page 127, presumably after a user has completed registration. Listed accounts are, from top to bottom, My Bank, My Travel, My Stocks, and My books. These exemplary accounts are intended to represent just some of possible accounts that may be configured to cobrand services by a user. Tool bar 139 also contains a scheduler function and a summarize function. An update function 133 is provided within interface 127 and adapted to enable a user to obtain periodic updates concerning accounts list 139 up to left.

It will be apparent to one with skill in the art that there may be many more functions provided an embedded in web page interface 127 that are illustrated in this example without departing from the spirit and scope of the present invention. The inventor intends that the functional elements represented herein are only exemplary of many such possible functions and interfaces that may be embedded into Web page 127.

In this particular example, a user accessing cobrand web page 127 may retrieve data summaries from the configured accounts illustrated in tool bar 139 by selecting each account and then selecting summarize using a summarize function, labeled as such, and provided within tool bar 139. In one embodiment, data may be retrieved from all of the listed accounts and summarized. A scheduling function, labeled as such, is provided within tool bar 139 allows a user to specify the time or time period for obtaining data, performing summaries, and so on. An update function 133 is available within interface 127 and adapted to allow a user to simply update any of the accounts listed in tool bar 139.

It will be apparent to one with skill in the art, that interface 127 may contain functionality and user-operated controls that are different than what is represented herein without departing from the spirit and scope of the present invention. The exact functionality built into interface 127 will depend on the services provided by the service providing company and the extent that such services are harnessed by cobrand partners.

It will also be apparent to one with skill in the art, that by providing a self-contained cobrand control panel 117 to be utilized in conjunction with cobrand architecture illustrated more particularly with servers 91, 93, and 95, of FIG. 4, much of the time and resource associated with prior-art cobranding techniques and architecture may be eliminated.

Ad-Broker Architecture

As described in the background section, prior-art advertising wherein ad servers are used to deliver banner ads over a data-packet-network (DPN) into common user interfaces is rather limited in efficiency by virtue of the fact that the various ad servers delivering ads do not associate similar ads with similar key words. As a result, disparate ads are routinely delivered to a same user that uses multiple interfaces. The inventor provides a method and apparatus that acts to normalize advertisements sent by disparate advertisement companies such that similar ads are delivered to multiple interfaces frequented by a same user.

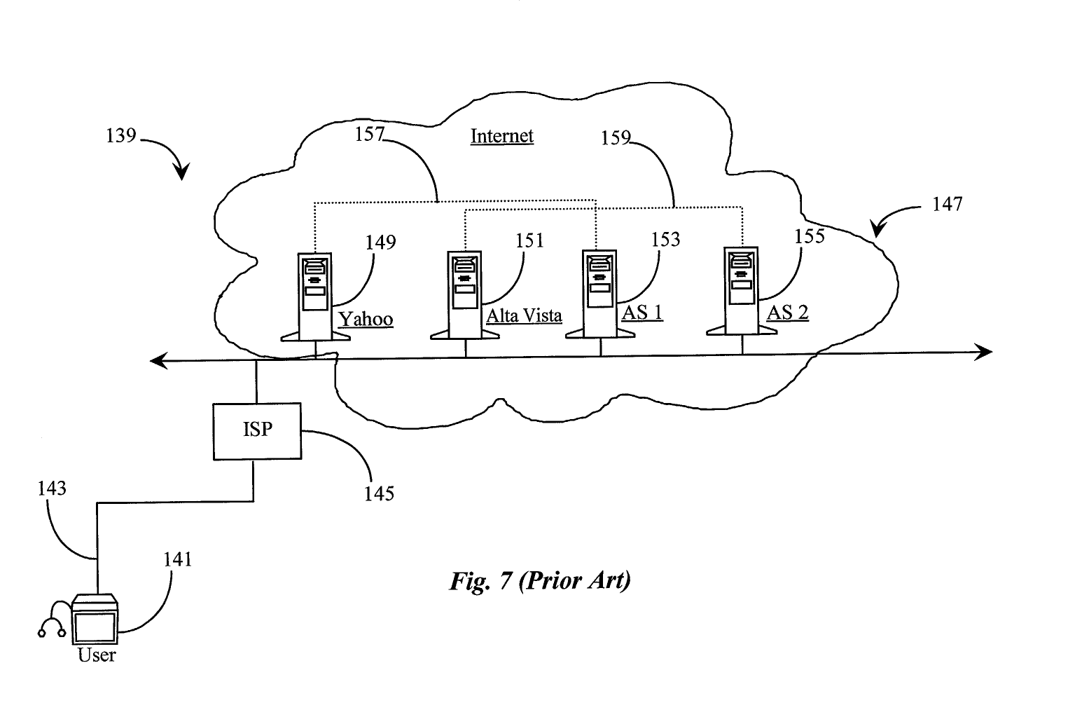

FIG. 7 is an overview of a communication network 139 wherein banner advertising is practiced according to prior-art. Network 139 utilizes an Internet network represented herein by element number 147 as a medium of communication. Internet 147 is chosen as a preferred communications medium in this prior-art illustration because of it's high public access characteristic.

A user 141 is illustrated, in this prior art example, as connected to an Internet Service Provider (ISP) 145 using an Internet capable appliance such as a personal computer running Internet capable software. Access to ISP 145 may be accomplished through a connection-oriented telephone network such as the well-known public-switch telephony network (PSTN) as is known in the art. An Internet access line 143 represents such as a cable-modem connection, a typical dial-up connection, an ISDN connection, a wireless digital connection, and so on. In this prior art example, ISP 145 is implemented as a dedicated provider using an Internet connection server (not shown) for providing Internet access. The arrangement illustrated herein for enabling user 141 to access Internet 147 is generally known in the art.

ISP 145 is connected to Internet 147 by virtue of an Internet access line as illustrated. Other equipment known in the art to be present and connected to a network such as Internet 147, for example, IP data routers, data switches, gateway routers, and the like, are not illustrated in this prior art example, but may be assumed to be present.

Four Internet file servers 149, 151, 153 and 155, are illustrated as connected to Internet 147, which is also represented by a double arrow intended to illustrate an Internet backbone. In this prior-art example, server 149 represents a portal server hosted by Yahoo™, which is a well-known company providing on-line search services. Server 151 represents yet another portal server hosted, in this example, by Alta Vista™, which is another well-known data-search provider.

Yahoo™ and Alta Vista™ are examples of well-known companies that provide, Internet portal services including user WEB-directories and/or search engine interfaces for performing data searches on the Internet. Other similar services known in the art are hosted by such companies as Hotbot™, Dog Pile™, Info-Search™, and so on. Functionality provided by servers 149 and 151 is typically dependent on the exact nature of services offered by the hosting companies. Generally speaking, however, it may be assumed that user 141 may access Internet 147 and perform, at least, a data-search operation from either server 149 or server 151.

Servers 153 and 155 are intended to represent advertising servers and are labeled AS1 and AS2, herein. As is well known in the art, banner advertisements are advertisements that are sent to Internet users. These ads are, in one aspect, generated based on keywords or search phrases that a user exerts at a search engine prompt. In another aspect, banner ads are associated with embedded keywords or phrases associated with a user's interface. Each banner advertising company uses a unique keyword selection to generate a certain banner ad. For example, if a user exerted the keyword travel while searching from server 149 hosted by Yahoo™, a banner ad may be sent from ad server 153 (AS 1) soliciting a trip to Hawaii. If a same user exerted the same keyword travel while searching from server 151 hosted by Alta Vista™, a banner ad may be sent from ad server 155 (AS 2), soliciting a trip to Florida. Dotted-line connectors 157 and 159 are used to draw an association between Yahoo™ server 149 and ad server 153, and between Alta Vista™ server 151 and ad server 155. This association is a business one and is typical in prior art practice. That is to say, that one advertising company will generally service one portal company. Therefore, ad servers 153 and 155 will use different key-word associations, which trigger differing advertisements. It may be assumed in this example, that servers 153 and 155 are hosted by disparate advertising companies in competition with each other.

According to prior-art practice, user 141 connects to Internet 147 via connection 143 and ISP 145. User 141 may elect to perform a search at Yahoo™ server 149 or at Alta Vista™ server 151. Although not shown herein, user 141 exerts a keyword or search phrase during a data-search session as is known in the art. Based on the entered keywords or phrases, various URLs are retrieved from each search-engine's or directory's data-base and the results are then displayed at the user interface.

As keywords or phrases are entered, such keywords or phrases may be used to cause banner ads from either server 153 or 155 (depending on which portal server is in use) to be delivered into the appropriate and associated user interface.

As described above, servers 153 and 155 are hosted by disparate advertising companies who create and provide banner ads to user interfaces at servers 149 and 151 respectively. Examples of advertisement companies engaged in banner advertising on Internet 147 would include such known companies as Double Click™ and Net Gravity™. The aforementioned advertising companies present their banner ads on behalf of the advertised company in exchange for a commission. For Example, Double Click™ may have an agreement with an airline company, such as American Airlines™. The agreement may be such that if a user is searching for airline tickets to Hawaii at server 151 (Alta Vista™), for example, and exerts a keyword phrase tickets to Hawaii, an American Airlines™ ad might be sent by virtue of the ad server 155, to the associated user interface. If, for example, user 141 responds to this ad by either clicking on the banner ad or elects to make a purchase of tickets from American Airlines™, it is assumed that a revenue of that click-through or sale would be paid to Double Click™ and perhaps a portion thereof to Alta Vista™. This business practice is well-known in the art.

In this prior-art example, banner ads are sent to a user based solely on exerted keywords or phrases exerted during a data-search and are rather impersonal. Furthermore, because servers 153 and 155 are not affiliated, there is no standardization of keywords to types of banner ads. As a result, there is a limited success or hit rate (user click) connected to delivered banner ads. Furthermore, a same user may get widely differing ads from portal to portal even though a same keyword or phrase is used in search engines. Similarly, active, in-depth, profiling of users is not typically performed by most service providers. Therefore, an ad agency does not have the ability to decide whether to send, for example, an ad from a real estate company that has featured homes in a $100,000 bracket or from a company that has featured homes in the $750,000 bracket. It would be ineffective to send an ad for a higher priced home to a moderate wage earner. The inventor provides a unique solution to the above-described limitations. Such a solution is described in detail below.

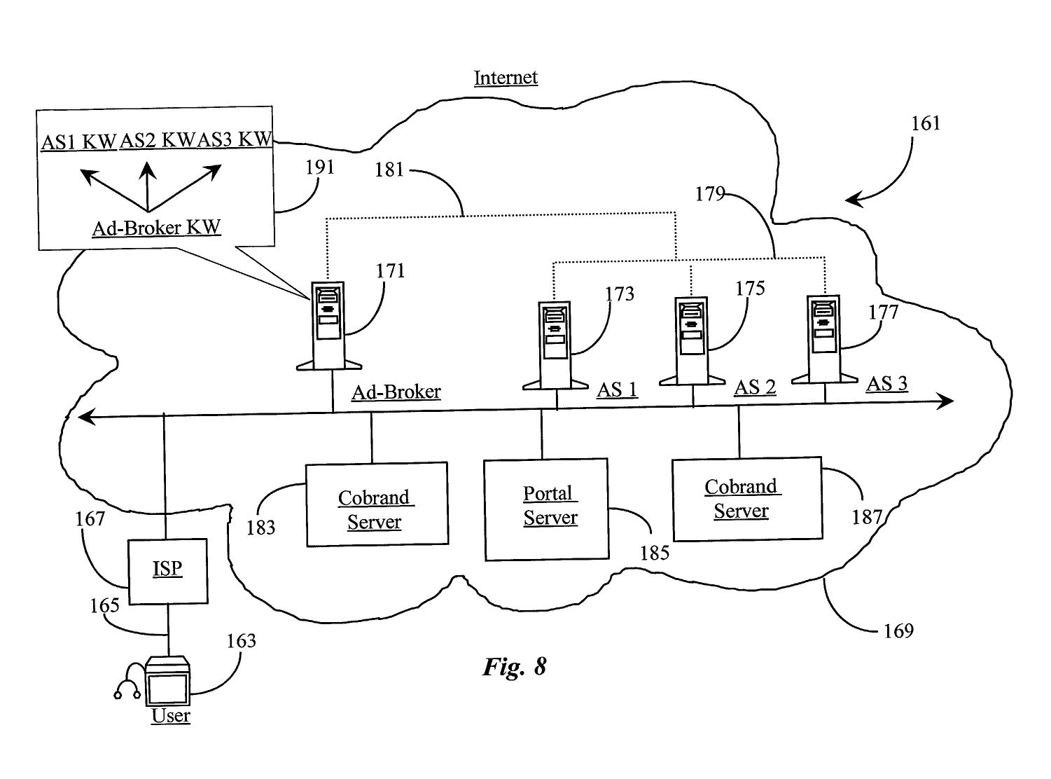

FIG. 8 is an overview of a communications network 161 wherein banner advertising is practiced according to an embodiment of the present invention. In this example of the present invention, the well-known Internet network, represented herein with element number 169 is chosen by the inventor as a preferred medium of communication for the same reasoning described in FIG. 7. However, this should not be considered limiting, as the invention could apply in other networks and combinations of networks.

In this embodiment, a user represented herein by element number 163 (Internet-appliance icon) is illustrated as connected to an ISP 167 by virtue of an Internet connection line 165. In turn, ISP 167 is connected to Internet network 169 via an Internet access line as is known in the art. User 163, line 165, and ISP 167, may be assumed to be analogous to user 141, line 143, and ISP 145, as described in FIG. 7. Also as described in FIG. 7, additional equipment known in the art to be present and connected to an Internet network such as Internet Network 169 may be assumed to exist in this example. Examples of such equipment include, but are not limited to, IP data routers, data switches, gateway routers, and the like. It may also be assumed in this example, that Internet connection is achieved through a connection-oriented network such as the well-known PSTN.

A double-arrowed line illustrated with an Internet network 169 represents an Internet backbone and may be assumed to contain all of the lines, connection points, and equipment known to make up the Internet network as a whole. Therefore, there's no geographic limit to the practice of the present invention.

In this example, three advertisement servers are illustrated as connected to the backbone of network 169. These are, ad server 173 (AS 1), ad server 175 (AS 2), and ad server 177 (AS 3). As described above, ad servers are hosted by advertising companies that send banner ads to a user interface based on search functions, and in some cases content keywords contained in within a user interface.

In a preferred embodiment of the present invention, a unique server labeled herein with element number 171 is provided within network 169 and adapted as a broker-server that communicates with each of servers 173-177. Server 171 is termed an ad-broker by the inventor. According to a unique method, ad-broker of 171 is dedicated to brokering the activities of servers 173-177 such that a standardization is created with respect to ad similarity in association with similar keyword attributes. Negotiation between ad broker 171 and servers 173-177 is illustrated herein by a dotted connector-tree 181.

A unique broker-software application 191 is provided and adapted to associate a specific set of keywords or phrases to individual ones of the banner-ads stored and servers 173-177. Application 191 is manipulated, in a preferred embodiment, by an ad-broker knowledge worker or administrator (not shown), the presence of which, may be assumed in this example. In actual practice, an ad-broker administrator would command a computerized workstation connected to the backbone of network 169, and would have access to server 171 and subsequently, servers 173-177. More about the function of application 191 will be provided below.

The example illustrated herein represents an embodiment wherein cobrand services are utilized as described with respect to FIGS. 4-6 above. In this regard, 2 cobrand servers are provided and illustrated herein as connected to the Internet backbone of Internet network 169. These are, cobrand server 183 and cobrand server 187. Servers 183 and 185 may be assumed to be analogous to servers 91-95 of FIG. 4 above. Also illustrated, is a portal server 185, which may be assumed to be analogous to portal server 103 of FIG. 4.

It was described further above, that cobranded services provide added functionality for subscribers to cobrand partners by redirecting them from partner-maintained servers to a user interfaces maintained in a server hosted by the service-providing company. In this way, users enjoy the benefit of existing services with added capability of managing multiple accounts from a single interface (data aggregation). It is desired by the inventor in this case that the banner ads streaming into these cobrand interfaces are somewhat normalized and personalized for users operating from within those interfaces. More particularly, it is desired that when a single user has multiple cobrand interfaces, that banner ads delivered thereto from disparate and companies are at least similar if not reflecting somewhat the status of the user as determined through profiling, and perhaps keywords or phrases derived from user content included within an interface.

Referring now back to FIG. 8, servers 183 and 187 are cobrand servers maintained in this example, by a company hosting portal server 185. Servers 149 and 151 of FIG. 7 are not illustrated in this embodiment, but may be assumed to be present. For example, server 183 might be a cobrand server setup for Yahoo™. Server 187 might be a cobrand server setup for Alta Vista™. There are many possibilities.

It may be assumed in this example, that user 163 has registered for a user interface in servers 183, 185, and 187. It may also be assumed in this embodiment, that one of servers 1733-177 serves banner ads to one of servers 183-187 through an extension of normal contractual arrangement pre-existing between the advertisement companies and the cobrand partner companies previously described. Because servers 173-177 are not affiliated with one another and do not return similar ads based on similar keywords or phrases, it is the job of ad broker 171 to insure that similar keywords or phrases exerted from, or in some embodiments, embedded into user interfaces invoke the presence of similar advertisements sourced from disparate ad servers 173-177.

In order to accomplish the above-described goal, the company hosting ad broker 171, which in this case, is the same company hosting portal server 185, must work closely with each of the companies hosting servers 173-177. For example, all of the keywords and associated banner-ad descriptions must be obtained from server 173. The just-described process must be repeated for servers 175 and 177 respectively. This process is illustrated logically within application 191 by an arrow tree associating ad-broker keywords to disparate sets of ad-server keywords.

In one embodiment, a set of generalized keywords generic to ad-broker 171 is mapped to existing keywords used at each of ad servers 173-177. In this embodiment, each ad description is reviewed in order to determine if the particular ad it is appropriate for a particular ad-broker-generated keyword. In this case, a broker keyword travel may be mapped to existing keyword vacation with respect to ad server 173, resort with respect to ad server 175, and lodge with respect to ad server 177. In each case, the actual advertisements equated to each existing keyword with respect to ad servers 173-177 would be carefully reviewed to insure that they are appropriate and similar in scope with respect to each other.

In another embodiment, ad broker keywords are used in-place of existing ad server keywords at the location of each ad server hundred 173-177. In this case, each ad server 173-177 would utilize two sets of keywords. One for delivering ads to normal interfaces and one for delivering ads to cobranded interfaces. Standard Internet address recognition may be used to determine whether an ad is destined for a normal interface or a cobranded interface.

Information about users subscribing to cobranded interfaces may be solicited for the purpose of assisting ad broker 171 in creating a flexible set of keywords that function to return ads from servers 173-177 that are not just normalized, but also somewhat personalized to the status of a user. For example, an annual income reported by a user may be used to enhance ads streamed to that user. For example, a keyword travel may be created by administrator working with application 191 such that the keyword has three states. Each state of the keyword may reflect a certain income range of a user. If a user's annual income is over $150,000 annually, then the keyword travel a may be employed. Users earning between $80,000 and $150,000 annually may be assigned travel b. Users earning between 0 and $80,000 annually may be assigned travel c. Banner ads stored within servers 173-177 may be carefully selected and associated with various states of keywords or phrases. It is noted herein, that the analytical process that must be performed for reviewing banner ads and mapping broker keywords to existing ad keywords, or replacing ad keywords with broker keywords is performed by an administrator or knowledge worker as previously described. However, and one embodiment this determination process may be performed electronically using knowledge-base technology.

In one embodiment, keywords may be parsed from user interfaces and complied electronically. For example, instead of a knowledge worker making a logical determination pertaining to which keywords will be broker keywords, keywords may be randomly parsed from the HTML or other language contained within banner ads themselves. A banner ad may have the keywords, “cross-stitching”, “knitting” and “women” contained therein. Banner ads of this nature, would only be sent to a user interface wherein profile information indicates that the particular user enjoys crafts and is of the female gender. In this case, a keyword set parsed from a particular banner ad is matched with the particular keyword set describing a user. Electronic matching of keywords sets may be accomplished from within ad broker 171 by virtue of broker application 191.

In an alternative embodiment of the present invention, user 163 may be a subscriber at portal server 185, which in this embodiment is not a cobrand server, but the portal server maintained by the same company hosting ad broker 171. It might be, that ad server 175 serves ads to portal server 185. In this case, ad broker 171 brokers ads for server 185 as well as servers 183 and 187, which cobrand servers.

In one embodiment of the present invention, a user subscribing to a portal service providing co-branded services may also utilize other portal services as described above. Through benefit of having an extensive profile knowledge of a particular user, the service-hosting company may work with advertising companies to extend ad normalization and customization to such users when they are utilizing normal portal interfaces such as Altavista™ or Yahoo™. Advertisements may be personalized to the extent of knowledge about a particular user by tracing the user's identity when he visits a non-cobranded interface. This can be accomplished through cookie exchange. In this way personalized ads may be caused to follow the user at other popular interfaces.

The inventor intends that the architecture, as well as, the general process illustrated herein represent exemplary embodiments for practicing the present invention. There are many other embodiments wherein the method and apparatus of present invention may be practiced. The method and apparatus of the present invention may be practiced via private individuals on the Internet, businesses operating on a WAN connected to the Internet, businesses operating via private WAN, and so on. There are many customizable situations.

Non-sensitized Data Summaries

According to one aspect of the present invention, a method and apparatus is provided for creating non-sensitized data summaries for distribution to user interfaces so that ordering users may view pertinent data about their Web accounts without being required to view or cache any sensitive data, which might be compromised through error or intent.

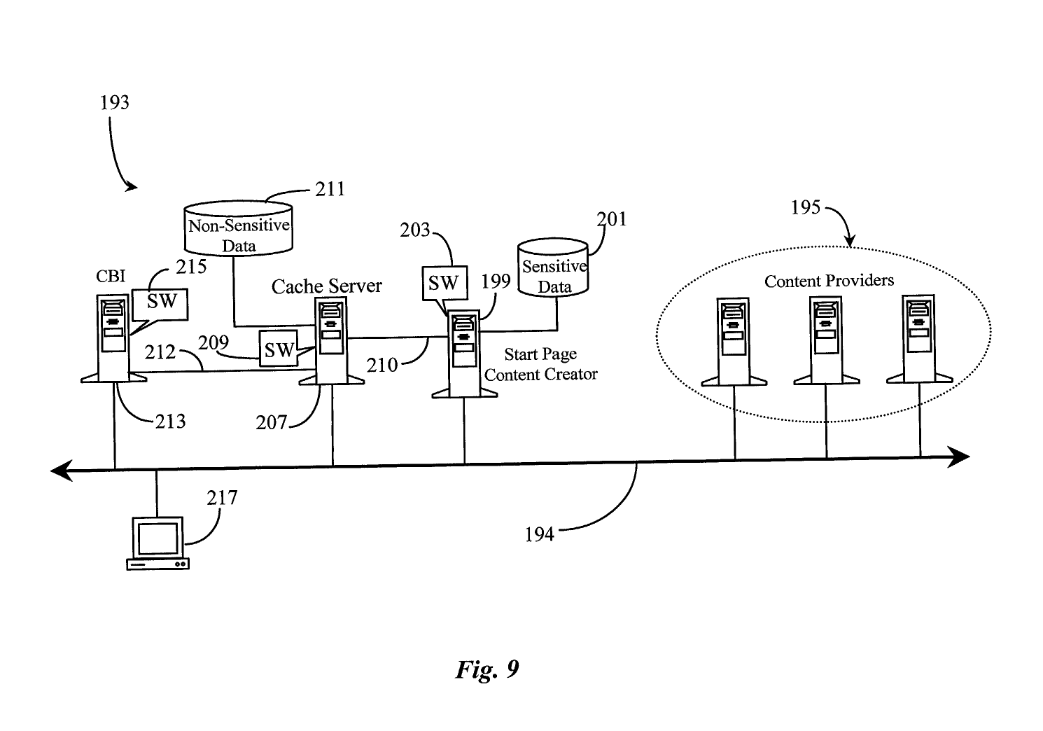

FIG. 9 is an architectural overview of a communication network 193 wherein non-sensitized data summaries are created according to an embodiment of the present invention. Communication network 193 comprises, in this example, an Internet network represented herein by an Internet backbone 194. Backbone 194 represents all the known lines, connection points, and equipment that make up the Internet network as a whole. Therefore, there is no geographic limit to the practice of the present invention. The inventor chooses the Internet as a representative DPN in a preferred example because of it's high public-access characteristic.

A user 217 is illustrated herein as a PC icon connected to backbone 194 via an Internet-connection line as is common in the art. User 217 is meant to represent a person using an access station to the Internet. User 217 may access network 193 via a variety of known Internet-capable appliances, however, a PC represents the most common method. It may be assumed in this example, that user 217 accesses network 193 through an ISP and a telephony network such as the well-known PSTN network. A common connection technology for this type of Internet access is dial-up/modem technology. Other technologies are equally applicable in this example.

Three data servers illustrated herein as grouped by a dotted ellipse and represented by element number 195 are, in this example, connected to backbone 194. Servers 195 are adapted as content servers hosted by content providers as so labeled. Servers 195 may be hosted collectively or separately by a wide range of business entities providing data and other services to consumers through network 193. For example, a banking institution may host a server 195 where users may access account information. A stock trading institution may provide a server 195 where users may trade and obtain up-to-date information about stocks in addition to personal account information. Servers 195 are, in this example, data-sources wherefrom data is obtained (by proxy) on behalf of requesting users, aggregated, and rendered available to requesting users.

As described with reference to case Ser. No. 09/573,697, a data-aggregation and summary service provides cobranded data services through interfaces maintained by the service-providing entity. User 217, in this example, accesses such services via Internet 194 from a cobrand-interface (CBI) server 213, which is also illustrated as connected to backbone 194. Server 213 is adapted to serve electronic information pages that retain the look and feel of the proprietary interface normally maintained by an entity contracting for use of server 213. Data results pertaining to summary information distributed to server 213 for a data-on-demand session between user 217 and server 213 are presented in a sub-window of the primary interfacing information page. In this way, users may access personal data without visibly leaving the look and functionality of a favorite home-site or portal page.

Server 213 represents part of a (grouping of network facilities acting in concert to provide summary data to user 217. Other servers involved in performing the stated task include a server 207 adapted as a cache data server and a server 199 adapted as a data-processing server. Both servers 207 and 199 are illustrated as connected to Internet backbone 194. Servers 199 and 207 are also illustrated as connected to each other via a high-speed data line 210. Server 207 is connected to server 213 by a high-speed data line 212. Utilizing data lines 210 and 212 is not specifically required in order to practice the present invention as each server may communicate with other servers over backbone 194, however, the presence of the extra data links in this example enhances data-communication and command capability between the connected servers.

Cache server 207 is adapted, as previously described, to hold prepared summary reports about user accounts including those from financial institutions, mortgage companies, investment firms, and so on. A data repository 211 is logically illustrated in this example as externally connected to server 207. In one embodiment repository 211 may be an internal component of server 207. Repository 211 is adapted to store data from user subscribed or routinely visited Web sites in such a form as to preclude any completely identifiable, sensitized, user-data from being included therein even if such sensitized data is indirectly ordered through an initiated request.

Server 199, as previously described, is adapted as a processing server, which is enabled to and capable of sorting through sensitized data and omitting any sensitive user-data such as credit card numbers, user-names and passwords, Social Security numbers, sensitive account numbers, and so on. A data repository 201 is logically illustrated as connected to server 199. Data repository 201 may be an external repository as shown herein, or it may be an internal data repository within server 199. Repository 201, also labeled Sensitive Data, is adapted to hold information including any sensitive data that user 217 has accessed and aggregated on his or her behalf. It may be assumed in this example, that all data processed by the system represented by servers 213, 207, and 199 has been accessed and obtained from one or more of content providers 195.

An instance of software (SW) 215 is provided within CBI server 213 and adapted to function as a secondary interface, which is embedded into the primary (cobrand) interface comprising an electronic information page (Web page) accessible by user 217. The secondary interface described is adapted as an interactive display for displaying summary data presented to user 217. In this way, user 217 may view and interact with his or her normal subscribed services and also view and interact with the secondary interface containing summarized data obtained and prepared by the system of the present invention.

An instance of software (SW) 209 is provided within cache server 207 and adapted as an application software (page server) responsible for managing and organizing summary information pages requested by user 217 through interaction with the secondary interface provided by SW 215. SW 209 functions to serve Web pages that are displayed in the secondary interface described above.

An instance of software (SW) 203 is provided within processing server 199 and adapted as a content creator (application) capable of omitting any sensitive data from data requested by user 217. Sensitive data may include but is not limited to credit card numbers, full account numbers, Social Security numbers, user names, passwords, personal-identification-numbers (PIN), and the like. In some cases, certain result data including exact account balance may be considered sensitive.

Software instances 203, 209, and 215 work in concert with each other to provide user 217 with a complete, non-sensitive data summary displayable in the form of an electronic information page within a secondary interface embedded on a primary Web interface served by server 213. By providing a non-sensitive data summary to user 217, server 213 is not required to perform a timeout for security reasons. Therefore, user 217 is only required to enter a single password in order to access his or her personal information. More detail regarding software instances 203, 209, and 215 will be provided further below.

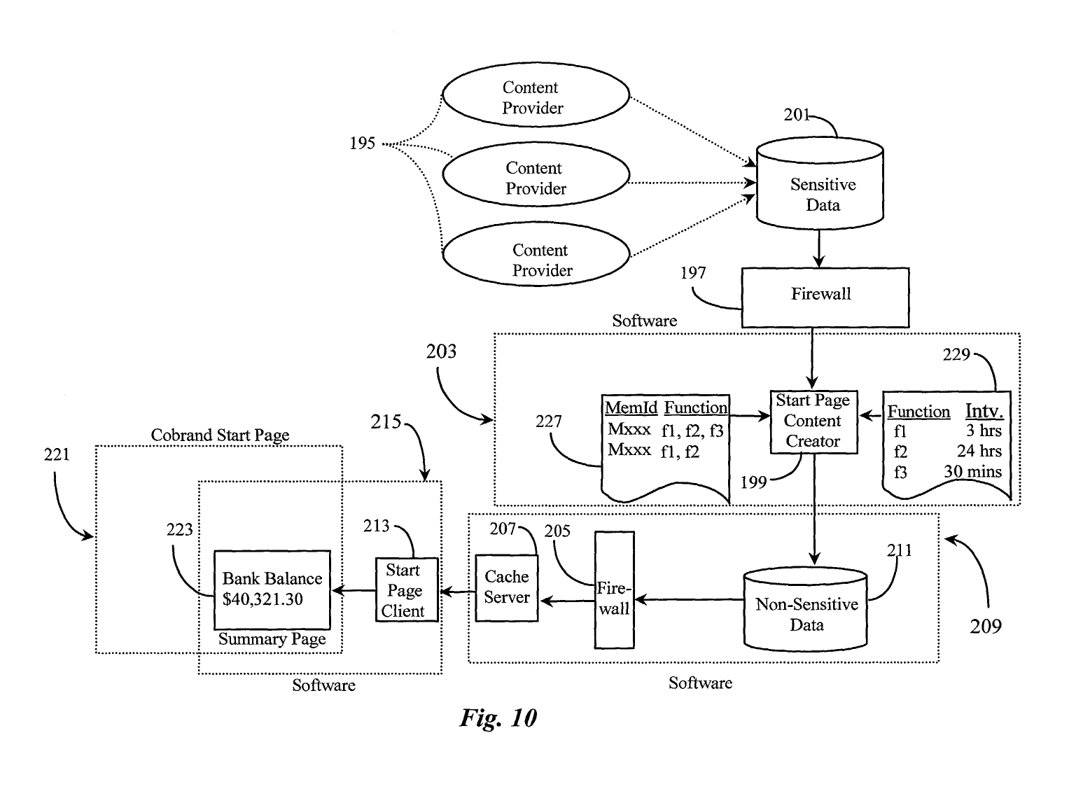

FIG. 10 is a block diagram illustrating software and data flow within the network 193 of FIG. 9 according to an embodiment of the present invention. Content providers 195, illustrated in FIG. 9 as network-connected servers are logically represented herein as simple ellipses. The data acquired from providers 195 is stored in data repository 201 including all sensitive data for all requesting users. In actual practice of the present invention, data procurement from providers 195 is performed by a proxy-navigation subsystem acting on individual user requests. In this example, such requests are repeat requests set up to execute automatically at stated periods over a span of time. Three unidirectional, dotted arrows represent the aggregation of data procured from providers 195 into repository 201. Repository 201 is, in this example, protected by a firewall 197. Other measures of security may also be employed in this example without departing from the spirit and scope of the present invention.

SW 203, (dotted rectangle) provides functionality of creating a start page as illustrated herein by a box labeled Start Page Content Creator 199, which is analogous to the function of server 199 of FIG. 9, hence retaining the same element number. It is noted herein, that a start page represents an HTML electronic information page in this example. In other embodiments, a start page may be created in other languages such as XML, HDML, and others. Creating a personalized start page for each requesting user is the main function of SW 203. A start page is analogous to a summary page. Part of the function that produces a summary page involves de-sensitizing requested data such that it may be presented in a non-sensitized form.

SW 203 is a software component that runs as a daemon. A daemon, as known in the art, is a process that runs in the background while another program is in operation. A daemon performs a specific operation at predefined times or in response to certain events. The term, daemon, is a UNIX term, however, many other operating systems provide support for daemons, which are sometimes called by other technical names as well. The well-known operating system Windows™, for example, refers to daemons as system agents. Typical daemon processes include print spooling, e-mail handling, and other tasks performed by programs doing administrative work for an associated operating system.

In this embodiment, the daemon running within SW 203 creates non-sensitized data summaries from sensitized data aggregated for users. SW 203 utilizes information about which functions to compute, for which users, and with what frequency. It pushes created summaries to repository 211 (non-sensitive data), which stores the non-sensitized summaries in the form of user-addressed and identified electronic information pages.

A data process 229 is illustrated herein as part of the functionality SW 203. Process 229 coordinates the ordered time periods for each start page creation as ordered by individual users. For example, a function (f1) under a function column of process 229 is equated to a time interval (Intvl column) of every 3 hrs. A function (f2) is equated to a 24 hr interval. A function (f3) is equated to a time interval of 30 mins. Functions f1-f3 are summary functions performed by SW 203 according to user input. For example, f1 may be a bank-balance summary, f2 may be a stock summary, f3 may be an investment summary, and so on. Functions f1-f3 are assigned by order to individual users as illustrated by a process 227. Process 227 is illustrated herein as having a column for member ID (memID) and a column for function. Therefore, as can be seen in the first row of process 227, a member (Mxxx) has assigned functions f1, f2, and f3.

It will be apparent to one with skill in the art that functions f1-f3 may represent virtually any type of data summary without departing from the spirit and scope of the present invention. The inventor chooses to exemplify financial-type summaries because they are typically accompanied by sensitive user data. A novel aspect of the present invention is the ability of start page creator 199 to actually create an interactive summary page containing all the useful while eliminating sensitized data.

SW 209 comprises a functionality of storing non-sensitive summary pages pushed to cache server 207 from content creator 199 upon availability. Newly created summaries are stored in repository 211 as previously described and as illustrated herein SW 209 is also responsible for serving requested summary pages to the appropriate users in on-demand fashion. A firewall 205 protects the stored in repository 211 from unauthorized access.

It is noted herein that the logical example presented herein differs connectively from the architecture presented in FIG. 9 above in that only one server function (Content Creator 199) is logically illustrated between sensitive data repository 201 and non-sensitive data repository 211. However, it can be assumed that in an embodiment utilizing three separate physical servers, 213, 207, and 199, that sever 199 communicates with server 207 before processed data is entered into repository 211. In one embodiment, SW instances may be adapted as one instance operating on one powerfull server having two data caches (repositories).

A cobrand start page 221 is illustrated in this example and represents the primary user-interface described within server 213 of FIG. 9. The functionality of server 213 is represented herein by a box of the same element number labeled Start Page Client. The server function of server 213 can be summarized as delivering requests from users and returning the requested data for display, in this case, within a secondary interface.

A summary page 223 is illustrated in this example and represents the secondary user-interface described as embedded into the primary user-interface within server 213 of FIG. 9. In this example, interface 223 denotes a bank balance represented herein by an arbitrary $ figure. Interface 223 may be a floating window in some embodiments, enabling the user to access more than one primary interface within a same server and still be able to access summary pages. Interface 223, of course, represents functions f1 in this example. As such, interface 223 is available for refresh every 3 hrs.

It will be apparent to one with skill in the art that interface 223 may contain many more balance figures that are represented herein without departing from the spirit and scope of the present invention. If there are more figures then can be viewed within interface 223, then scroll functionality and window-sizing functionality may be utilized. Moreover, functionality with reference to exact summary process may be enhanced to include averaging, and other types of standard computations. Solution-oriented summary technology is known by an available to the inventor.

The basic concept of providing interface 223 encompasses more than just providing an interface for displaying summary pages. Interface 223 is also utilized for requesting which ones of the possible plurality of completed summary pages will be displayed. In one embodiment, summaries may be automatically requested upon user log-in to cobrand start page 221. In another embodiment, a user may log-in, and then invoke an initialization feature (not shown) present within interface 223. In this embodiment an interactive icon for retrieving all summaries may be invoked. In some cases, there is a separate icon present within interface 223 for each separate type of summary available to the user.

Upon initialization of interface 223 and upon invocation of one or more options presented therein, start page client 213 sends a request to cache server 207 for the appropriate non-sensitive summary pages contained within repository 211. These summaries are presented on demand to the invoking user within interface 223. If a user has more than one available summary which are displayable within interface 223, then he or she may select which one or ones to display by selecting the appropriate selection icons. In some cases, interface 223 may be enhanced to spawn as many separate windows as are required for single-summary viewing of multiple summaries. In still another embodiment, interface 223 may be maximized in terms of size, and then framed to contain more than one summary page. There are many such possibilities.

The software process of de-sensitizing data and creating ordered summaries, as exemplified by SW 203, is ongoing in this example. That is to say that users pre-configure a request to execute thereafter at pre-defined time-intervals. Because of this fact, all summary pages are pushed to repository 211. Summary pages are pulled from repository 211 by users operating client (server) 213. In this embodiment, data summaries may expire if not picked up between stated intervals. Such summary pages may simply be automatically deleted from the system upon arrival of an updated summary page replacing the former.

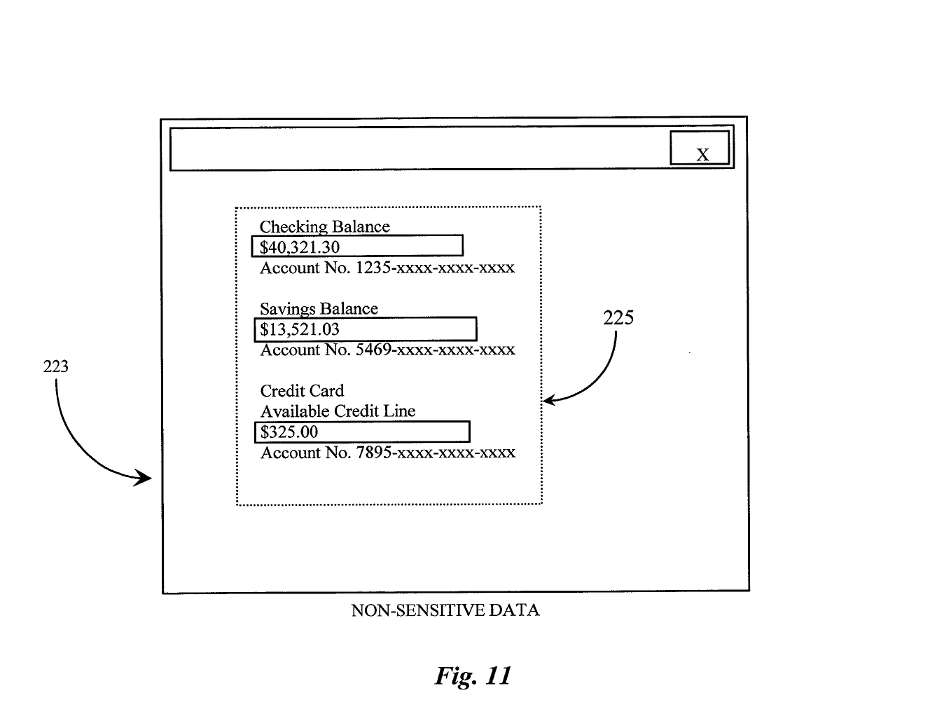

FIG. 11 is a plan view of cobrand interface 223 of FIG. 10 illustrating exemplary non-sensitized data results according to an embodiment of the present invention. Interface 223, as described above, is presented in a primary cobrand interface (221, FIG. 10) as a secondary interface, which may be in the form of an interactive window. In this example, a non-sensitive data summary-block 225 is illustrated as enclosed by a dotted rectangle. Summary block 225 contains an exemplary checking balance, an exemplary savings balance, and an exemplary credit card balance in stated order reading from top to bottom.

It is noted herein, that there are varying definitions of what one might consider to be non-sensitive data. In this example, summary block 225 includes the first 4 digits of the account numbers associated with each numerical balance. In this embodiment, entire account numbers are de-sensitized except for the first few digits of each number. In this way, a cobrand user may identify which balances actually belong to which accounts without displaying enough information for an onlooker to obtain an actual account number. Credit card numbers, bank account numbers, Social Security numbers, and so on may be displayed in this fashion such that they are rendered unusable to anyone other than the authorized client.

In one embodiment of the present invention, a user may be allowed to pre-configure his or her own degree of non-sensitivity for his or her own display window. For example, some users may have a plurality of savings accounts all with one particular bank. Each account may belong to a particular member of his family. If so authorized, such a user may require knowledge of all the balances at any given time. Such balances listed in one interface may contain partial account numbers associated therewith as described in this example, or may be present with other identifiers such as, perhaps only the year that each family member was born, the first four digits of each members Social Security number, or some other non-revealing criteria. It may be however, that such a user has chosen a very high degree of non-sensitivity. In this case, actual balances or partial identifiers may not be displayed at all. Instead, a text message may simply read that 4 of the users accounts at a particular bank have been updated recently. An interactive link to the bank Web site may be provided to allow navigation to the site.

In other example of a high degree of non-sensitivity, a user may have a message within summary block 225 concerning an e-mail account. It may read simply that the user has received 10 e-mails within the past 3 hrs. If a lower degree of non-sensitivity were applied to this example, the message may include partial identifiers of the e-mail authors, as well as, a non-sensitized summary of the first few lines of each message. There are many possibilities.

The concept of flexibility in the degree of non-sensitivity as applied to summary creation and distribution functions to facilitate a wide array of users. For example, users operating from public areas such as an open workplace a benefit from a high degree of non-sensitivity, while those operating from private areas may enjoy a lower degree of non-sensitivity thereby gaining more useful summary information within interface 223. It is noted herein that non-sensitive summary data of a very high degree of non-sensitivity may simply be no more than a notice of an update at a particular Web site. Moreover, it may be require that a user navigate to the site in question and supply a password to learn more about the update.

Referring now back to FIG. 10, SW 203 may utilize various techniques in both identifying and de-sensitizing sensitive data according to a degree pre-configured by a user. In a very low degree of non-sensitivity, SW 203 is capable of comparing sensitive data in aggregation (repository 201) with user-profile data tagged as sensitive data, and then partially or completely de-sensitizing certain aspects of the data. In this way, depending on degree, of course, a user may attain maximum summary information from his cobrand interface without being required to leave the interface of suffering a timeout requiring re-login. In a very high degree of non-sensitivity, SW 203 would provide essentially simple notification of any particular data states that exist without revealing any useful data.

It will be apparent to one with skill in the art that rules governing the allowable degree of sensitivity regarding distributed data summaries may be engineered and implemented according to enterprise directive without departing from the spirit and scope of the present invention. It might be that a certain low level of non-sensitivity may still require a timeout to occur if there is an inordinate period of inactivity.

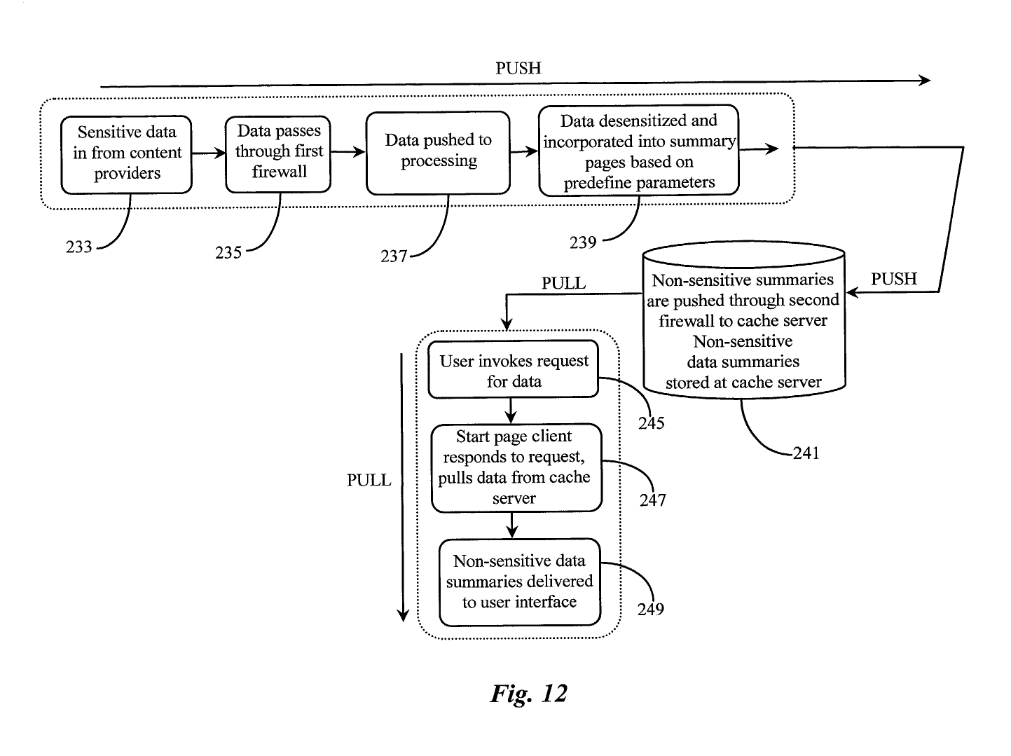

FIG. 12 is a flow diagram illustrating system and user steps involved in ordering and receiving non-sensitized data summaries according to an embodiment of the present invention. At step 233, sensitive data is received from content providers and is aggregated in a secure storage repository. Such data will include all user account numbers, ID numbers, and other sensitive identifiers. Moreover some of the aggregated data itself may be considered sensitive such as confidential e-mails, performance reviews, medical information and the like. At step 235, the aggregated data is sorted per requesting user and passes through a first firewall.

At step 237, the aggregated data continues on to processing according to timed schedule. At step 239, the data is computed per user-summary request, including pre-configured degree of non-sensitivity. This process is individual to each user and is defined by such tasks as data comparison with user-profile information, applying rules of non-sensitivity, rules for data presentation, and so on. It is noted herein that the data acquisition and summary processes are interval ordered for each type of summary.

At step 241, non-sensitive data summaries are pushed through a second firewall to a second non-sensitive repository (cache server function). At this point in the process, summary pages are complete and are organized in data storage under the associated users whom authorized and pre-configured summary processes. The prepared data summaries remain resident in non-sensitive storage until requested, or until they expire.

At step 245, a user invokes a request to receive a non-sensitive summary report or reports from a secondary interface embedded within a primary cobranded interface. This request may be automatic, such as when a user logs in to the cobrand interface. In one embodiment, a user may select from an array of interactive function buttons provided within the secondary interface window in order to request certain summaries. This action occurs sometime after successful login. In still another embodiment, one function button requests all available summaries.

At step 247, a start-page client function responds to the interaction of step 245 by opening a secure connection to the cache server and sending the request for summary retrieval. At step 249, the requested summary or summaries are displayed within the user-interface, more specifically, in the secondary interface whereupon the data may be viewed and ,in some cases, interacted with. It is noted in this process that the first portion follows a push model while the remainder follows a pull model. This is simply due to the nature of timed function applied to the process.

It will be apparent to one with skill in the art that the steps described herein may be altered in content and order without departing from the spirit and scope of the present invention. For example, if the SW of the present invention is implemented as a single application executing on a single server, steps 235, 237, and 241 may be eliminated from the process.

It will also be apparent to one with skill in the art that the practice of the present invention is not limited, in terms of accessibility, to desktop appliances, but may be implemented with wireless appliances as well. It is the scope of the present invention to provide summary data from user-held personal accounts to users accessing available interfaces from data-accessing devices in such a way that the summary information is de-sensitized by order of degree to allow device display and retention of information without requiring a timeout function for security reasons. The method and apparatus of the present invention may also apply in certain respects to general data aggregated and summarized on behalf of users wherein the particular user wishes not to be associated with certain classes of data.

The present invention as taught herein and above should be afforded the broadest of scope. The spirit and scope of the present invention is limited only by the claims that follow.

What is claimed is:

1. A software application for creating and distributing non-sensitized summaries from sensitized data aggregated on behalf of users comprising:
a data processing portion of the software for de-sensitizing data and incorporating the de-sensitized data into the form of a data summary;
a data caching portion of the software for storing, managing, and serving non-sensitive data summaries; and
a user-interface portion of the software for enabling requests for data summaries and for enabling display of the requested summaries, characterized in that a user operating the interface portion of the software initiates a request to the data caching portion of the software, the request triggering service of a completed, non-sensitive data summary or summaries created by the data processing portion of the software.

2. The software application of claim 1, wherein the application is implemented in portions on a system of cooperating server nodes connected to a data-packet-network.

3. The software application of claim 2, wherein the data-packet-network is the Internet network.

4. The software application of claim 3, wherein the sensitized data is obtained from a plurality of data sources by proxy using a network navigation and data-gathering subsystem.

5. The software application of claim 4, wherein the sensitive portions of data in aggregation are compared to sensitive portions of user-profile data for the purpose of identifying data for de-sensitizing.

6. The software application of claim 5, wherein the sensitive portions of data in aggregation are partially de-sensitized and displayed with portions thereof intact to enable user identification of summary items contained in data summaries.

7. The software application of claim 5, wherein the sensitive portions of data in aggregation are entirely eliminated and not displayed.

8. The software application of claim 5, wherein the user-interface portion comprises a secondary interactive display window embedded within a primary user interface.

9. The software application of claim 8, wherein the secondary interactive display window may be manipulated to spawn additional display windows.

10. The software application of claim 9, wherein spawned additional display windows display additional summaries.

11. The software application of claim 1, further comprising a configuration tool for enabling users to configure a rule specifying a degree of non-sensitivity, the rule functioning, to govern how sensitive data portions are de-sensitized.

12. The software application of claim 4, wherein the non-sensitive data summaries are HTML-based information pages.

13. The software application of claim 4, wherein the non-sensitive data summaries are XML-based information pages.

14. The software application of claim 4, wherein the non-sensitive data summaries are created using a markup language rooted in the class of HTML derived languages.

16. A server-driven system for creating and distributing non-sensitive data summaries from sensitized data aggregated on behalf of users comprising:
a data-packet-network for facilitating communication to, from, and within the system;
a processing server connected to the data-packet-network for de-sensitizing data from aggregation and for creating data summaries using the de-sensitized data;
a cache server connected to the data-packet-network for accessing, obtaining, and serving non-sensitive data summaries to requesting users, and
a user-interface server connected to the data-packet-network for facilitating requests from users for summaries and for enabling service and display of the requested summaries.

17. The server-driven system of claim 16, wherein the communication between components of the system and communication between practitioners of the system and components of the system occurs on a data-packet-network.

18. The server-driven system of claim 17, wherein the data-packet-network is the Internet network.

19. The server-driven system of claim 18, wherein the sensitized data is obtained from a plurality of data sources by proxy using a network navigation and data-gathering subsystem.

20. The server-driven system of claim 19, wherein the sensitive portions of data in aggregation are compared to sensitive portions of user-profile data for the purpose of identifying data for de-sensitizing.

21. The server-driven system of claim 19, wherein the sensitive portions of data in aggregation are partially de-sensitized and displayed with portions thereof intact to enable user identification of summary items contained in data summaries.

22. The server-driven system of claim 19, wherein the sensitive portions of data in aggregation are entirely eliminated and not displayed.

23. The server-driven system of claim 19, wherein the non-sensitive data summaries are HTML-based information pages.

24. The server-driven system of claim 19, wherein the non-sensitive data summaries are XML-based information pages.

25. The server-driven system of claim 19, wherein the non-sensitive data summaries are created using a markup language rooted in the class of HTML derived languages.

26. A method for creating and distributing non-sensitive data summaries from data aggregated on behalf of users comprising steps of:
(a) receiving and aggregating data on behalf of requesting users;
(b) de-sensitizing the aggregated data;
(c) incorporating the de-sensitized data into the form of one or more non-sensitive data summaries;
(d) requesting the non-sensitive data summaries or summary to be delivered to an interface during a data session; and
(e) displaying the non-sensitive summary or summaries for user review.

27. The method of claim 26 wherein steps (a)-(e) are practiced in conjunction with a data-packet-network

28. The method of claim 27 wherein the data-packet-network is the Internet network.

29. The method of claim 28 further comprising a step between (a) and (b) for identifying sensitive data portions through database comparison.

30. The method of claim 29 wherein the database used in the comparison is a user-profile database.
